(19) United States
(12) Patent Application Publication
(10) Pub. No.: US 2025/0083161 A1
(43) Pub. Date: Mar. 13, 2025

(54) DISCHARGING NOZZLE ASSEMBLY AND BIDET INCLUDING THE SAME

(71) Applicant: COWAY Co., Ltd., Gongju-si (KR)

(72) Inventors: Hyun Sik BANG, Gongju-si (KR); Jin Won PARK, Gongju-si (KR); Jae Hong LEE, Gongju-si (KR); Young Pyo KIM, Gongju-si (KR); Ji Won HAN, Gongju-si (KR); Young Joo KIM, Gongju-si (KR)

(73) Assignee: COWAY Co., Ltd., Gongju-si (KR)

(21) Appl. No.: 18/817,381

(22) Filed: Aug. 28, 2024

(30) Foreign Application Priority Data
Sep. 7, 2023 (KR) 10-2023-0118968

(51) Int. Cl. B05B 1/34; E03D 9/08

(52) U.S. Cl. CPC B05B 1/3426; E03D 9/08

(57) ABSTRACT

A discharging nozzle assembly and a bidet including the same are disclosed. A discharging nozzle assembly according to an aspect of the present invention may include an inlet housing that communicates the outside and receives fluid; an outlet housing coupled with the inlet housing, and having an outlet housing space formed therein communicating with the inlet housing and the outside, respectively; and a vortex forming member supported by the inlet housing and the outlet housing, respectively, and configured to form the flow of the fluid transmitted in communication with the inlet housing and the outlet housing, respectively, into a vortex, wherein the vortex forming member includes a vortex base communicating with the outlet housing space and the outside, wherein the vortex base includes a vortex base hollow formed inside and communicating with the outside; and a vortex base inlet that communicates the vortex base hollow space and the outlet housing space and extends eccentrically with respect to the center of its cross-section to form the flow of the fluid into a vortex.

### CROSS-REFERENCE TO RELATED APPLICATION

This application claims priority to and the benefit of Korean Patent Application No. 10-2023-0118968, filed on Sep. 7, 2023, the disclosure of which is incorporated herein by reference in its entirety.

### TECHNICAL FIELD

The present invention relates to a discharging nozzle assembly and a bidet including the same, and more particularly, to a discharging nozzle assembly that can clean a bowl by discharging water without a water pump and a bidet including the same.

### BACKGROUND OF THE INVENTION

A bidet is a type of sanitary bowl and refers to an apparatus used to clean the genitals or anus area after toileting. In the past, bidets were commonly installed and used in commercial buildings such as offices and hotels. Recently, as interest in hygiene has increased, the number of bidets being equipped and used in ordinary homes is increasing.

A bidet is installed and used in a toilet bowl. The bidet is installed on the rear side of the bowl, which is exposed when the toilet bowl cover is opened, and discharges water for cleaning toward the front side.

Meanwhile, as the bidet is installed in the bowl, a part of the bowl, that is, the rear side, is covered by the bidet. Accordingly, when a user wants to clean a bowl, it is more difficult to effectively clean the area where the bidet is installed than other areas. Accordingly, the cleanliness of this part of the bowl deteriorates, and there is a risk that the cleanliness of the entire bowl deteriorates.

To solve the above situation, bidets that can clean or sterilize bowls have recently been released.

Korean Registered Patent Document No. 10-1712612 discloses a bowl sterilization discharging apparatus that is movable in length direction. Specifically, it discloses a bowl sterilization discharging apparatus that can wash and sterilize bowl using bowl sterilizing water discharged in the form of vortices and mists, including a bowl sterilization mist discharging unit that receives the bowl sterilizing water from the bowl sterilizing water discharging flow path and discharge it in the form of mist.

However, the bowl sterilization discharging device disclosed by the related art only discharges the bowl sterilizing water in the form of mist. Therefore, although the discharged bowl sterilizing water can be discharged over a large area, there is a risk that the sterilizing or cleaning effect of the discharged bowl sterilizing water may be reduced.

Korean Registered Patent Document No. 10-1741922 discloses a cleaning apparatus. It discloses a cleaning apparatus that has a vortex forming unit in a nozzle tip unit and can move the nozzle using the movement motor included in the sub cleaning nozzle and discharge sterilizing or cleaning water.

However, the cleaning apparatus disclosed in the above-described related art only provides a vortex forming unit in the form of a cap of the nozzle tip unit. In addition, the sterilizing or cleaning water flowing into the vortex forming unit flows along a second flow path located eccentrically with respect to the nozzle tip unit. Therefore, there is a risk that sterilizing or cleaning water may not flow uniformly into the vortex forming unit, thereby reducing vortex formation, and consequently reducing the sterilizing or cleaning effect of the bowl.

### RELATED ART DOCUMENT

### Patent Document

Korean Patent Registration No. 10-1712612 (2017 Mar. 6.)
Korean Patent Registration No. 10-1741992 (2017 May 31.)

### SUMMARY OF THE INVENTION

### Technical Problem

The present invention is to solve the above problems, and the present invention is directed to providing a discharging nozzle assembly having a structure capable of improving cleaning power, and a bidet including the same.

The present invention is also directed to providing a discharging nozzle assembly having a structure capable of improving discharging power, and a bidet including the same.

The present invention is also directed to providing a discharging nozzle assembly having a structure in which a fluid for cleaning can flow smoothly, and a bidet including the same.

The present invention is also directed to providing a discharging nozzle assembly having a structure capable of forming a flow of fluid in a desired shape without a separate power source, and a bidet including the same.

The present invention is also directed to providing a discharging nozzle assembly having a structure capable of miniaturization, and a bidet including the same.

The problems of the present invention are not limited to those mentioned above, and other problems not mentioned will be clearly understood by those of ordinary skill in the art from the following description.

### Technical Solution

According to an aspect of the present invention, provided is a discharging nozzle assembly according to an exemplary embodiment of the present invention, including an inlet housing that communicates the outside and receives fluid; an outlet housing coupled with the inlet housing, and having an outlet housing space formed therein communicating with the inlet housing and the outside, respectively; and a vortex forming member supported by the inlet housing and the outlet housing, respectively, and configured to form the flow of the fluid transmitted in communication with the inlet housing and the outlet housing, respectively, into a vortex, wherein the vortex forming member includes a vortex base communicating with the outlet housing space and the outside, wherein the vortex base includes a vortex base hollow formed inside and communicating with the outside; and a vortex base inlet that communicates the vortex base hollow space and the outlet housing space and extends eccentrically with respect to the center of its cross-section to form the flow of the fluid into a vortex.

In this case, a discharging nozzle assembly may be provided in which the vortex base includes a vortex base body that is seated on an inner surface of the outlet housing and extends to surround the vortex base hollow in the radial direction, and the vortex base inlet extends at a predetermined angle with respect to the radial direction of the vortex base body.

In addition, a discharging nozzle assembly may be provided in which a plurality of vortex base inlets are provided, and the plurality of vortex base inlets are disposed to face each other with the center of the vortex base body therebetween.

In this case, a discharging nozzle assembly may be provided in which each of the vortex base body and the vortex base hollow is formed to have a circular cross-section, and the vortex base inlet includes a first vortex base inlet positioned to be biased to one side with respect to the center of the vortex base body; and a second vortex base inlet positioned to be biased to the other side with respect to the center of the vortex base body.

In addition, a discharging nozzle assembly may be provided in which the vortex forming member includes an inlet vortex housing positioned in the outlet housing space, supported by the inlet housing, communicating with the inlet housing to receive the fluid from the outside, and communicating with the outlet housing space to transmit the fluid.

In this case, a discharging nozzle assembly may be provided in which the inlet vortex housing includes an inlet vortex housing body extending in the height direction and supported by the inlet housing; an inlet vortex hollow formed inside the inlet vortex housing body, with one side thereof facing the inlet housing being open and the other side facing the outlet housing being closed; and an inlet vortex opening formed recessed into one side of the outer circumference of the inlet vortex housing body and extending in a radial direction to communicate the outlet housing space and the inlet vortex hollow.

In addition, a discharging nozzle assembly may be provided in which the inlet vortex housing includes an inlet vortex rib extending in the horizontal direction and supported by an inner surface of the outlet housing so that the center of the cross-section of the vortex forming member and the center of the cross-section of the inlet housing are located on the same axis, and a flow space in which the fluid flows is formed between an outer surface of the inlet vortex housing and the inner surface of the outlet housing.

In this case, a discharging nozzle assembly may be provided in which a plurality of inlet vortex ribs are provided, and the plurality of inlet vortex ribs are arranged spaced apart from each other in the length direction and width direction of the inlet vortex housing.

In addition, a discharging nozzle assembly may be provided in which the discharging nozzle assembly further includes an outlet vortex housing accommodated in the outlet housing space, communicating with the outlet housing space and the vortex base hollow space, respectively, and supported by the vortex base.

In this case, a discharging nozzle assembly may be provided in which the outlet vortex housing includes an outlet vortex rib formed to protrude outwardly from an outer surface and supported by an inner surface of the outlet housing so that the center of the cross-section of the vortex forming member and the center of the cross-section of the outlet housing are located on the same axis, and a flow space in which the fluid flows is formed between an outer surface of the outlet vortex housing and the inner surface of the outlet housing.

In addition, a discharging nozzle assembly may be provided in which the outlet vortex housing includes an outlet vortex housing body extending in the height direction and coupled to the vortex base; and an outlet vortex hollow formed inside the outlet vortex housing body, extending in the height direction, and having each end in the extension direction open to communicate with the outlet housing space and the vortex base hollow, respectively.

In this case, a discharging nozzle assembly may be provided in which the vortex forming member includes an inlet vortex housing positioned in the outlet housing space, communicating with the inlet housing to receive the fluid from the outside, communicating with the outlet housing space to transmit the fluid, and coupled to the outlet vortex housing; and a vortex communication opening formed between the inlet vortex housing and the outlet vortex housing and communicating with the outlet housing space and the outlet vortex hollow, respectively.

In addition, a discharging nozzle assembly may be provided in which the outlet housing includes an outlet housing nozzle extending in a direction opposite to the inlet housing; and an outlet housing nozzle space formed through the inside of the outlet housing nozzle and communicating with the vortex base hollow and the outside, respectively.

In this case, a discharging nozzle assembly may be provided in which the outlet housing nozzle space is formed to have different cross-sectional areas at least partially along the extension direction of the outlet housing nozzle, and the outlet housing nozzle includes a plurality of outlet housing inner circumferences surrounding the outlet housing nozzle space in the radial direction along the extension direction thereof.

In addition, a discharging nozzle assembly may be provided in which among the plurality of outlet housing inner circumferences, any one outlet housing inner circumference located farthest from the vortex forming member is formed rounded to be convex toward the center of the outlet housing nozzle space, while the diameter of its cross-section increases along a direction opposite to the vortex forming member.

In addition, according to an aspect of the present invention, provided is a bidet, including a discharging nozzle assembly according to an exemplary embodiment of the present invention; a tank device connected to the discharging nozzle assembly and configured to provide the fluid to the discharging nozzle assembly; and a water inlet unit that is connected to the tank device and receives the fluid from the outside and provides it to the tank device.

### Advantageous Effects

According to the configuration, the discharging nozzle assembly and the bidet including the same according to an exemplary embodiment of the present invention can have improved cleaning power.

In addition, according to the configuration, the discharging nozzle assembly and the bidet including the same according to an exemplary embodiment of the present invention can have improved discharging power.

In addition, according to the configuration, the discharging nozzle assembly and the bidet including the same according to an exemplary embodiment of the present invention can allow the fluid for cleaning to flow smoothly.

In addition, according to the configuration, the discharging nozzle assembly and the bidet including the same according to an exemplary embodiment of the present invention can form a flow of fluid in a desired shape without a separate power source.

In addition, according to the configuration, the discharging nozzle assembly and the bidet including the same according to an exemplary embodiment of the present invention can be miniaturized.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

FIG. 1 is a block diagram showing the configuration of a bidet according to an exemplary embodiment of the present invention.

FIG. 2 is a perspective view illustrating a discharging nozzle assembly provided in the bidet of FIG. 1.

FIG. 3 is a front view illustrating the discharging nozzle assembly of FIG. 2.

FIG. 4 is an exploded perspective view illustrating the discharging nozzle assembly of FIG. 2.

FIG. 5 is a perspective view illustrating an inlet housing provided in the discharging nozzle assembly of FIG. 2.

FIG. 6 is a D-D cross-sectional view illustrating the inlet housing of FIG. 5.

FIG. 7 is a perspective view illustrating an outlet housing provided in the discharging nozzle assembly of FIG. 2.

FIG. 8 is an E-E cross-sectional view illustrating the outlet housing of FIG. 7.

FIG. 9 is a partial enlarged cross-sectional view of portion A illustrating the outlet housing of FIG. 7.

FIG. 10 is a perspective view illustrating a vortex forming member provided in the discharging nozzle assembly of FIG. 2.

FIG. 11 is a front view illustrating the vortex forming member of FIG. 10.

FIG. 12 is a side view illustrating the vortex forming member of FIG. 10.

FIG. 13 is a plan view illustrating the vortex forming member of FIG. 10.

FIG. 14 is a bottom view illustrating the vortex forming member of FIG. 10.

FIG. 15 is an exploded perspective view illustrating the vortex forming member of FIG. 10.

FIG. 16 is an F-F cross-sectional view illustrating the vortex forming member of FIG. 10.

FIG. 17 is a G-G cross-sectional view illustrating the vortex forming member of FIG. 10.

FIG. 18 is a C-C cross-sectional view illustrating the vortex forming member of FIG. 10.

FIG. 19 is an A-A cross-sectional view illustrating a flow formed inside the discharging nozzle assembly of FIG. 2.

FIG. 20 is a B-B cross-sectional view illustrating a flow formed inside the discharging nozzle assembly of FIG. 2.

FIG. 21 is a C-C cross-sectional view illustrating a flow formed inside the discharging nozzle assembly of FIG. 2.

### DETAILED DESCRIPTION OF THE EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

In the following description, in order to clarify the features of the present invention, descriptions of some components may be omitted.

The term “communication” used in the following description means that one or more members are connected to each other so as to be in fluid communication. In an embodiment, communication may be formed by a member such as a conduit, a pipe, a tubing, or the like. In the following description, communication may be used in the same sense as one or more members are being “fluidically connected” to each other.

The term “fluid” used in the following description refers to any form of material that flows by external force and whose shape or volume can be changed. In an embodiment, the fluid may be a liquid such as water or a gas such as air.

The terms “above or upper side”, “below or lower side”, “left side”, “right side”, “front side”, and “rear side” used in the following description will be understood with reference to the coordinate system shown throughout the accompanying drawings.

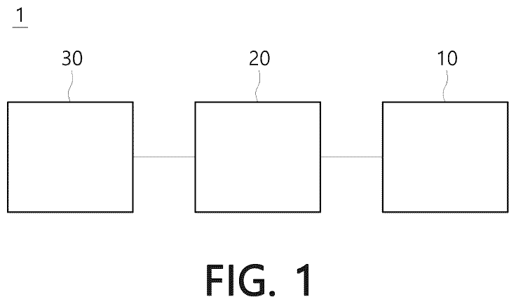

Referring to FIG. 1, a configuration of a bidet 1 according to an exemplary embodiment of the present invention is illustrated as an example. The bidet 1 according to the illustrated embodiment includes a discharging nozzle assembly 10, a tank device 20, and a water inlet unit 30.

The water inlet unit 30 is a part where the bidet 1 is fluidly connected to the outside to receive a fluid. In an embodiment, the water inlet unit 30 may be fluidly connected to an external tap or the like.

The tank device 20 is fluidly connected to the water inlet unit 30. The tank device 20 may receive and store the fluid introduced through the water inlet unit 30. The tank device 20 may generate sterilizing water using the received and stored fluid. In an embodiment, the tank device 20 may be configured to include an electrolyzed water (EW) module that generates sterilizing water through an electrolysis method. The fluid or the generated sterilizing water stored in the tank device 20 may be delivered to the discharging nozzle assembly 10.

In another embodiment, the fluid delivered to the tank device 20 may not be stored in the tank device 20, but may be delivered directly to the discharging nozzle assembly 10 through the tank device 20. In this embodiment, the tank device 20 may be configured to heat fluid passing therein.

In any case, it is sufficient as long as the fluid delivered from the water inlet unit 30 may be delivered to the discharging nozzle assembly 10 through the tank device 20. The tank device 20 is fluidly connected to the discharging nozzle assembly 10.

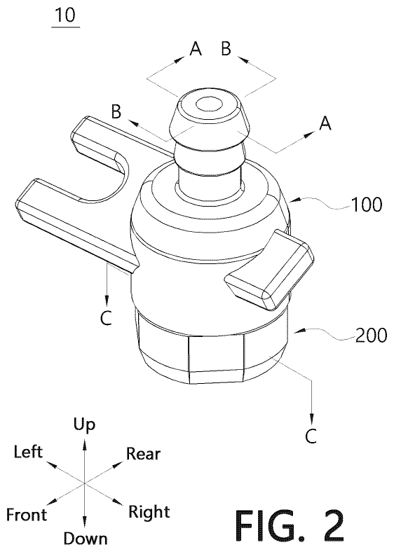

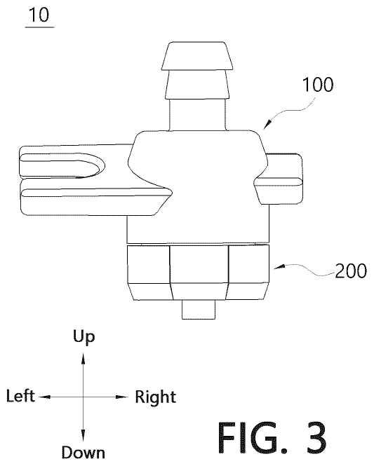

Referring to FIGS. 2 to 4, a discharging nozzle assembly 10 according to an exemplary embodiment of the present invention is illustrated. The discharging nozzle assembly 10 may be fluidly connected to the tank device 20 described above and may receive fluid or generated sterilizing water. In addition, the discharging nozzle assembly 10 may communicate with the internal space of a bowl (not shown) and may discharge the delivered fluid or generated sterilizing water into the bowl (not shown).

The sterilizing water delivered to the discharging nozzle assembly 10 may be formed into a vortex and discharged into the bowl (not shown). Accordingly, the intensity of the discharging force and the discharging angle can be increased, thereby improving the cleaning or sterilizing effect of bowl (not shown) by the discharged sterilizing water.

In this case, the discharging nozzle assembly 10 may discharge sterilizing water in the form of a vortex even if a separate power source, for example, a pump, is not provided. Accordingly, the discharging nozzle assembly 10 and the bidet 1 including the same can be miniaturized. Furthermore, power consumed by the discharging nozzle assembly 10 and the bidet 1 including the same can be minimized.

In the above-described embodiment, one side in the height direction of the discharging nozzle assembly 10, that is, the upper side in the illustrated embodiment, may be fluidly connected to the tank device 20. In addition, the other side in the height direction of the discharging nozzle assembly 10, that is, the lower side in the illustrated embodiment, may be open to communicate with the internal space of the bowl (not shown). The fluid or generated sterilizing water may be introduced into the upper side of the discharging nozzle assembly 10, flow along its interior, and then be discharged into the internal space of the bowl (not shown) through the lower side.

In the illustrated embodiment, the discharging nozzle assembly 10 includes an inlet housing 100, an outlet housing 200, and a vortex forming member 300.

The inlet housing 100 constitutes a part of the outer shape of the discharging nozzle assembly 10. The inlet housing 100 is a part where the discharging nozzle assembly 10 is fluidly connected to the tank device 20. A space in which the fluid provided from the tank device 20 flows is formed inside the inlet housing 100.

The inlet housing 100 constitutes one side of the discharging nozzle assembly 10 in the height direction. In the illustrated embodiment, the inlet housing 100 constitutes the upper side of the discharging nozzle assembly 10.

The inlet housing 100 is coupled to the outlet housing 200. The inlet housing 100, together with the outlet housing 200, constitutes a portion where the discharging nozzle assembly 10 is exposed to the outside. In an embodiment, the inlet housing 100 may be detachably coupled to the outlet housing 200.

The inlet housing 100 at least partially accommodates the vortex forming member 300. In the illustrated embodiment, the inlet housing 100 accommodates one side in the height direction, that is, the upper side, of the vortex forming member 300. The inlet housing 100 may support the vortex forming member 300. As will be described later, the inlet housing 100 may be coupled to the vortex forming member 300 in a supporting form without being mechanically coupled to the vortex forming member 300.

Accordingly, the degree of freedom of arrangement of the inlet housing 100, the outlet housing 200, and the vortex forming member 300 is improved, so that the discharging nozzle assembly 10 can be easily manufactured.

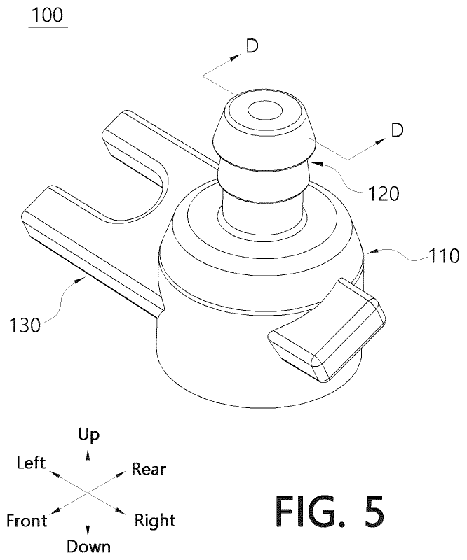

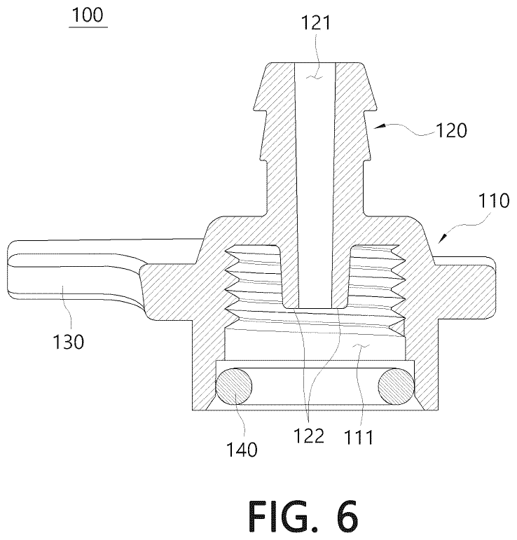

In an embodiment shown in FIGS. 5 to 6, the inlet housing 100 includes an inlet housing body 110, an inlet extension 120, a coupling member 130, and a sealing member 140.

The inlet housing body 110 constitutes a part of the outer shape of the inlet housing 100. The inlet housing body 110 is a part where the inlet housing 100 is coupled to the outlet housing 200. In addition, a space may be formed inside the inlet housing body 110 to accommodate the vortex forming member 300.

The inlet housing body 110 may be of any shape capable of being fluidly connected to the tank device 20 and receiving fluid. In addition, the inlet housing body 110 may be coupled to the outlet housing 200 and may have any shape capable of accommodating and supporting the vortex forming member 300. In the illustrated embodiment, the inlet housing body 110 has a cylindrical shape having a circular cross-section and having a height in the up-down direction. The shape of the inlet housing body 110 may be changed to correspond to the shape of the outlet housing body 210.

The inlet housing body 110 is coupled to the inlet extension 120. One side of the inlet housing body 110 in the height direction, that is, the upper side in the illustrated embodiment, is continuous with the inlet extension 120. The space formed inside the inlet housing body 110 communicates with the space formed inside the inlet extension 120. Accordingly, the fluid or the generated sterilizing water accommodated in the tank device 20 may flow into the interior of the inlet housing body 110 through the inlet extension 120.

The inlet housing body 110 is coupled to the coupling member 130. One side of the outer circumference of the inlet housing body 110, that is, the left side in the illustrated embodiment, is continuous with the coupling member 130. The inlet housing body 110 may be coupled to other components through the coupling member 130.

The sealing member 140 is located inside the inlet housing body 110. When the inlet housing 100 is coupled to the outlet housing 200, the inside of the inlet housing body 110 is sealed by the sealing member 140 to block any communication with the outside.

Meanwhile, the inlet housing body 110 may be detachably coupled to the outlet housing body 210. In an embodiment, the inlet housing body 110 may be screwed to the outlet housing body 210. In the above embodiment, threads may be formed on the inner circumferential surface of the inlet housing body 110.

In the illustrated embodiment, the inlet housing body 110 includes an inlet housing space 111.

The inlet housing space 111 is a space formed inside the inlet housing body 110. The inlet housing space 111 is defined by being at least partially surrounded by the inner surface of the inlet housing body 110. In the illustrated embodiment, the inlet housing space 111 is partially surrounded by the inner circumferential surface and the upper inner surface of the inlet housing body 110.

The inlet housing space 111 communicates with an inlet hollow 121. The fluid or the generated sterilizing water accommodated in the tank device 20 may be introduced into the inlet housing space 111 through the inlet hollow 121.

The inlet housing space 111 at least partially accommodates the outlet housing 200. In the illustrated embodiment, the inlet housing space 111 accommodates the outlet housing body 210 extending in the height direction, that is, in the up-down direction.

The inlet housing space 111 communicates with an outlet housing space 211 formed inside the outlet housing 200. The sterilizing water introduced into the inlet housing space 111 may flow out into the outlet housing space 211.

The inlet housing space 111 at least partially accommodates the vortex forming member 300. In the illustrated embodiment, the inlet housing space 111 accommodates one side in the height direction, that is, the upper portion, of the vortex forming member 300.

The inlet housing space 111 communicates with the interior of the vortex forming member 300. The sterilizing water introduced into the inlet housing space 111 may pass through the vortex forming member 300 and then be discharged to the outside through the outlet housing 200.

The inlet housing space 111 may be of any shape capable of accommodating the outlet housing body 210 and the vortex forming member 300. In the illustrated embodiment, the inlet housing space 111 is formed as a cylindrical space having a circular cross-section and a height in the up-down direction.

One side of the inlet housing space 111 in the height direction, that is, the upper side in the illustrated embodiment, is partially open to communicate with the inlet hollow 121. The other side in the height direction of the inlet housing space 111, that is, the lower side in the illustrated embodiment, is formed open and provides a passage for accommodating the outlet housing body 210.

The inlet extension 120 constitutes another part of the outer shape of the inlet housing 100. The inlet extension 120 is a part where the inlet housing 100 is fluidly connected to the tank device 20. Although not shown, a member for fluid connection, such as a fitting or hose, may be coupled to the inlet extension 120.

A space (i.e., an inlet hollow 121 to be described later) is formed inside the inlet extension 120. The space of the inlet extension 120 is fluidly connected to the tank device 20. The fluid or the generated sterilizing water accommodated in the tank device 20 may flow into the inlet extension 120. In addition, the space of the inlet extension 120 communicates with the inlet housing space 111. The sterilizing water delivered to the inlet extension 120 may flow out into the inlet housing space 111.

The inlet extension 120 is continuous with the inlet housing body 110. In the illustrated embodiment, the inlet extension 120 is continuous with the upper outer surface of the inlet housing body 110.

The inlet extension 120 is continuous with the inlet housing body 110 and may be of any shape that can be fluidly connected to the tank device 20. In the illustrated embodiment, the inlet extension 120 has a cylindrical shape having a circular cross-section and having a height in the up-down direction.

In this case, a stepped portion whose radius decreases as it goes from the upper side to the lower side may be formed on the outer circumferential surface of the inlet extension 120. Accordingly, the coupled state between the inlet extension 120 and the tank device 20 can be stably maintained.

In the illustrated embodiment, the inlet extension 120 includes an inlet hollow 121 and a support end 122.

The inlet hollow 121 is a space formed inside the inlet extension 120. The inlet hollow 121 extends in the length direction of the inlet extension 120, i.e., in the up-down direction in the illustrated embodiment. Each end in the extension direction of the inlet hollow 121, that is, the upper end and the lower end in the illustrated embodiment, are each formed open. The upper end of the inlet hollow 121 communicates with the internal space of the tank device 20. The lower end of the inlet hollow 121 communicates with the inlet housing space 111.

The inlet hollow 121 may have a shape corresponding to the shape of the inlet extension 120. In the illustrated embodiment, the inlet hollow 121 is formed as a cylindrical space having a circular cross-section and a height in the up-down direction. In this case, the centers of the cross-sections of the inlet housing body 110, the inlet housing space 111, the inlet extension 120, and the inlet hollow 121 may be disposed on the same axis.

The support end 122 constitutes one side in the length direction of the inlet extension 120, i.e., the lower end in the illustrated embodiment. The support end 122 is located in the inlet housing space 111. The support end 122 supports the vortex forming member 300 accommodated in the inlet housing space 111 on one side in the height direction, that is, on the upper side in the illustrated embodiment.

In other words, the support end 122 may press the vortex forming member 300 in a direction from the upper side to the lower side. Accordingly, the vortex forming member 300 accommodated in the inlet housing space 111 may be supported on the one side in the height direction and may not be shaken.

The support end 122 may have a shape corresponding to the shape of the inlet extension 120 or the inlet hollow 121. In the illustrated embodiment, the support end 122 is radially spaced apart from the inner circumference of the inlet housing body 110 and extends in the outer circumferential direction, and is formed in a ring shape with an inlet hollow 121 formed therein.

The coupling member 130 is a part where the inlet housing 100 is coupled with other components of the discharging nozzle assembly 10. The coupling member 130 is continuous with one side of the outer circumference of the inlet housing body 110, that is, the left side in the illustrated embodiment. The coupling member 130 extends in a radial direction from the outer circumference of the inlet housing body 110.

The sealing member 140 hermetically couples the inlet housing 100 and the outlet housing 200. The sealing member 140 is configured to seal the inlet housing 100 and the outlet housing 200 to block communication with the outside.

The sealing member 140 is located in the inlet housing space 111. The sealing member 140 may be positioned opposite to the inlet extension 120 along the height direction of the inlet housing space 111. In the illustrated embodiment, the sealing member 140 is located below the inlet housing space 111.

The sealing member 140 may be in contact with the inner circumference of the inlet housing body 110. The sealing member 140 may be in contact with the outer circumference of the outlet housing body 210 accommodated in the inlet housing space 111. In this case, the sealing member 140 may be tightly coupled to the inner circumference of the inlet housing body 110 and the outer circumference of the outlet housing body 210, respectively.

The sealing member 140 may be of any shape capable of hermetically coupling the inlet housing 100 and the outlet housing 200. In the illustrated embodiment, the sealing member 140 is formed in a ring shape.

The sealing member 140 may be formed of a material having a predetermined elastic force. The sealing member 140 may be pressed by the inlet housing 100 or the outlet housing 200 to deform the shape and store restoring force, restored to its original shape by the restoring force, and may be tightly coupled to the inlet housing 100 and the outlet housing 200, respectively. In an embodiment, the sealing member 140 may be formed of a silicone or rubber material.

The outlet housing 200 constitutes the remainder of the outer shape of the discharging nozzle assembly 10. The outlet housing 200 is configured such that the discharging nozzle assembly 10 communicates with the internal space of the bowl (not shown). A space communicating with the inlet housing space 111 is formed inside the outlet housing 200. The sterilizing water delivered to the inlet housing space 111 may be discharged into the internal space of the bowl (not shown) through the outlet housing 200.

The outlet housing 200 constitutes the other side of the discharging nozzle assembly 10 in the height direction. In the illustrated embodiment, the outlet housing 200 constitutes the lower side of the discharging nozzle assembly 10.

The outlet housing 200 is coupled to the inlet housing 100. The outlet housing 200, together with the inlet housing 100, constitutes a portion where the discharging nozzle assembly 10 is exposed to the outside. As described above, the outlet housing 200 may be detachably coupled to the inlet housing 100.

The outlet housing 200 at least partially accommodates the vortex forming member 300. In the illustrated embodiment, the outlet housing 200 accommodates the other side in the height direction, that is, the lower side, of the vortex forming member 300. The outlet housing 200 may support the vortex forming member 300. Similar to what was described above, the outlet housing 200 may be coupled to the vortex forming member 300 in a supporting form without being mechanically coupled to the vortex forming member 300.

Accordingly, as described above, the degree of freedom of arrangement of the inlet housing 100, the outlet housing 200, and the vortex forming member 300 is improved, so that the discharging nozzle assembly 10 can be easily manufactured.

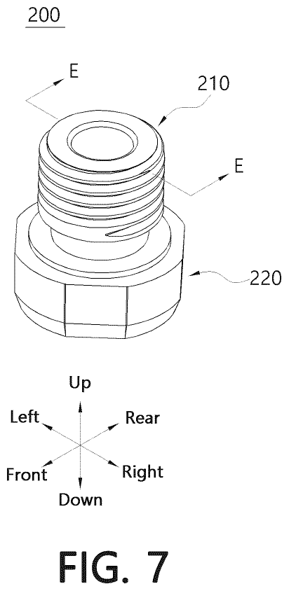

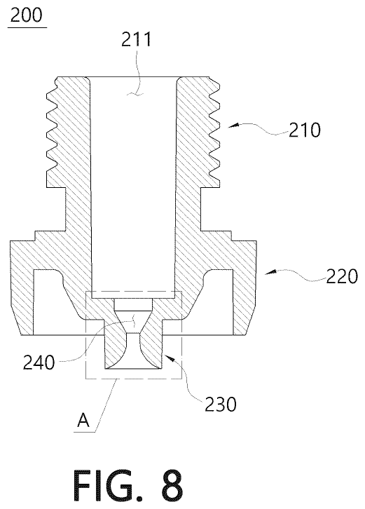

In an embodiment shown in FIGS. 7 to 9, the outlet housing 200 includes an outlet housing body 210, an outlet housing base 220, an outlet housing nozzle 230, and an outlet housing nozzle space 240.

The outlet housing body 210 constitutes a part of the outer shape of the outlet housing 200. The outlet housing body 210 is a part where the outlet housing 200 is coupled to the inlet housing 100. In addition, a space may be formed inside the outlet housing body 210 to accommodate the vortex forming member 300.

The outlet housing body 210 is at least partially accommodated in the inlet housing space 111. When the outlet housing body 210 is accommodated in the inlet housing space 111, the outlet housing body 210 may not be exposed to the outside.

The outlet housing body 210 may be of any shape that can be accommodated in the inlet housing space 111 and its interior can communicate with the inlet housing space 111. In the illustrated embodiment, the outlet housing body 210 has a cylindrical shape having a circular cross-section and having a height in the up-down direction.

In the above embodiment, the cross-sectional diameter of the outlet housing body 210 may be formed to be less than or equal to the inner diameter of the inlet housing body 110.

In an embodiment in which the inlet housing 100 and the outlet housing 200 are screwed together, threads may be formed on the outer circumference of the outlet housing body 210. The threads may be screwed together with the threads formed on the inner surface of the inlet housing body 110.

The outlet housing body 210 is coupled to the inlet housing body 110. One side of the outlet housing body 210 in the height direction, that is, the upper side in the illustrated embodiment, is accommodated in the inlet housing body 110.

The outlet housing body 210 is coupled to the outlet housing base 220. The other side of the outlet housing body 210 in the height direction, that is, the lower side in the illustrated embodiment, is continuous with the outlet housing base 220.

The outlet housing body 210 accommodates the vortex forming member 300. The outlet housing body 210 may support the vortex forming member 300 in the radial direction. In addition, the outlet housing body 210 may support the vortex forming member 300 on the other side in the height direction, that is, on the lower side in the illustrated embodiment.

In the illustrated embodiment, the outlet housing body 210 includes an outlet housing space 211.

The outlet housing space 211 is a space formed inside the outlet housing body 210. The outlet housing space 211 is defined by being at least partially surrounded by the inner surface of the outlet housing body 210. In the illustrated embodiment, the outlet housing space 211 is partially surrounded by the inner circumferential surface and the lower inner surface of the outlet housing body 210.

The outlet housing space 211 communicates with the inlet housing space 111. The sterilizing water introduced into the inlet housing space 111 may be introduced into the outlet housing space 211. In addition, the vortex forming member 300 accommodated in the inlet housing space 111 may extend to the outlet housing space 211.

The outlet housing space 211 partially accommodates the inlet extension 120. In the illustrated embodiment, the outlet housing space 211 accommodates the lower portion of the inlet extension 120 extending in the up-down direction.

The outlet housing space 211 at least partially accommodates the vortex forming member 300. In the illustrated embodiment, the outlet housing space 211 accommodates the other side in the height direction, that is, the lower portion, of the vortex forming member 300.

The outlet housing space 211 communicates with the interior of the vortex forming member 300. The sterilizing water introduced into the outlet housing space 211 may pass through the vortex forming member 300 and then be discharged to the outside.

The outlet housing space 211 communicates with the outside. The sterilizing water that has passed through the vortex forming member 300 may be discharged into the internal space of the bowl (not shown).

The outlet housing space 211 may have any shape that can accommodate the vortex forming member 300 and communicate with the inlet housing space 111 and the outside. In the illustrated embodiment, the outlet housing space 211 is formed as a cylindrical space having a circular cross-section and a height in the up-down direction.

One side in the height direction of the outlet housing space 211, that is, the upper side in the illustrated embodiment, may be formed open to accommodate one side in the height direction of the inlet extension 120, that is, the lower side. In addition, the other side of the outlet housing space 211 in the height direction, that is, the lower side in the illustrated embodiment, is formed open to communicate with the outlet housing nozzle space 240.

The outlet housing base 220 constitutes another part of the outer shape of the outlet housing 200. The outlet housing base 220 is a part that supports the inlet housing 100. In addition, the outlet housing base 220 surrounds the outlet housing nozzle 230 radially outwardly.

The outlet housing base 220 supports the inlet housing 100. Specifically, the outlet housing base 220 supports the lower end of the inlet housing body 110. In addition, the outlet housing base 220 may support the sealing member 140.

The outlet housing base 220 is coupled to the outlet housing body 210. One side of the outlet housing base 220 in the height direction, that is, the upper side in the illustrated embodiment, is continuous with the lower side of the outlet housing body 210. The other side in the height direction of the outlet housing space 211, that is, the lower side in the illustrated embodiment, is located inside the outlet housing base 220. That is, the outlet housing space 211 may extend to the inside of the outlet housing base 220.

Therefore, it can be said that the outlet housing base 220 at least partially accommodates the vortex forming member 300.

The outlet housing base 220 is continuous with the outlet housing nozzle 230. The other side of the outlet housing base 220 in the height direction, that is, the lower side in the illustrated embodiment, is continuous with the upper side of the outlet housing nozzle 230.

The outlet housing base 220 surrounds the outlet housing nozzle 230 in a radial direction. In the illustrated embodiment, the outlet housing base 220 is spaced apart from the outlet housing nozzle 230 in a radially outward direction and extends along the outer circumferential direction of the outlet housing nozzle 230.

The outlet housing base 220 may be of any shape that can be formed to support the inlet housing 100 and surround the outlet housing nozzle 230. In the illustrated embodiment, the outlet housing base 220 has a three-dimensional figure shape having an annular cross-section and having a height in the up-down direction.

The outlet housing nozzle 230 defines a flow path through which the sterilizing water passing through the vortex forming member 300 is discharged to the outside. A space (that is, an outlet housing nozzle space 240 to be described later) is formed inside the outlet housing nozzle 230. The outlet housing nozzle 230 may define a flow path for the sterilizing water flowing along the space by surrounding it in a radial direction.

The outlet housing nozzle 230 is coupled to the outlet housing base 220. The outlet housing nozzle 230 is continuous with the other side in the height direction of the outlet housing base 220, that is, the lower side in the illustrated embodiment. The outlet housing nozzle 230 is surrounded by the outlet housing base 220 in a radial direction.

An outlet housing nozzle space 240 is formed inside the outlet housing nozzle 230. The outlet housing nozzle 230 surrounds the outlet housing nozzle space 240 in a radial direction.

The outlet housing nozzle 230 supports the vortex forming member 300 accommodated in the outlet housing space 211. In the illustrated embodiment, the outlet housing nozzle 230 supports the other side in the height direction, that is, the lower side, of the vortex forming member 300.

The outlet housing nozzle 230 may be of any shape that can be continuous with the outlet housing base 220, define the outlet housing nozzle space 240, and support the vortex forming member 300. In the illustrated embodiment, the outlet housing nozzle 230 has a cylindrical shape with an outlet housing nozzle space 240 formed therein, having an annular cross-section and having a height in the up-down direction.

The outlet housing nozzle 230 may be divided into a plurality of parts along its shape. The plurality of parts may be formed to be continuous with each other along the height direction of the outlet housing nozzle 230, that is, in the up-down direction in the illustrated embodiment, but have different shapes.

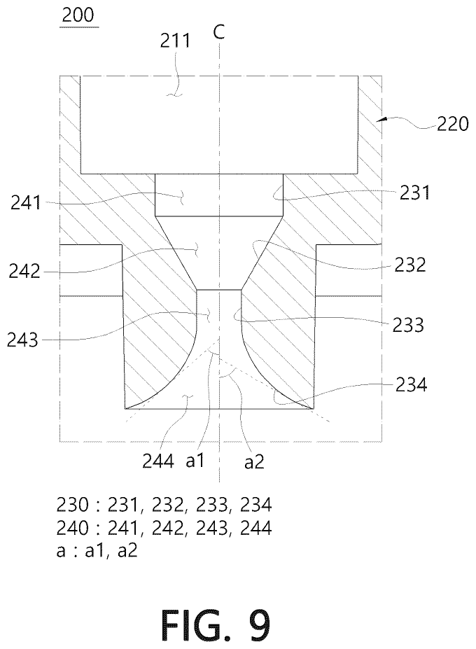

In the illustrated embodiment, the outlet housing nozzle 230 includes a first outlet housing inner circumference 231, a second outlet housing inner circumference 232, a third outlet housing inner circumference 233, and a fourth outlet housing inner circumference 234 (best shown in FIG. 9).

The first outlet housing inner circumference 231 constitutes a part of the inner circumference of the outlet housing nozzle 230. The first outlet housing inner circumference 231 is located on one side of the inner circumference of the outlet housing nozzle 230 in the height direction, that is, on the upper side in the illustrated embodiment.

The first outlet housing inner circumference 231 extends at a predetermined angle with the upper surface of the outlet housing nozzle 230. In an embodiment, the predetermined angle may be a right angle. In the above embodiment, the first outlet housing inner circumference 231 may be formed to have a constant inner diameter along its height direction, that is, the up-down direction in the illustrated embodiment.

The first outlet housing inner circumference 231 surrounds a part of the outlet housing nozzle space 240 in the height direction. In the illustrated embodiment, the first outlet housing inner circumference 231 surrounds the uppermost first outlet housing nozzle space 241 in the radial direction.

The first outlet housing inner circumference 231 is continuous with the second outlet housing inner circumference 232.

The second outlet housing inner circumference 232 constitutes another part of the inner circumference of the outlet housing nozzle 230. The second outlet housing inner circumference 232 is located between the first outlet housing inner circumference 231 and the third outlet housing inner circumference 233 along the height direction among the inner circumference of the outlet housing nozzle 230. In the illustrated embodiment, the second outlet housing inner circumference 232 is located below the first outlet housing inner circumference 231 and above the third outlet housing inner circumference 233.

The second outlet housing inner circumference 232 extends at a predetermined angle with the first outlet housing inner circumference 231. In an embodiment, the predetermined angle may be an obtuse angle. In the above embodiment, the second outlet housing inner circumference 232 may be formed to have different inner diameters along its height direction, that is, the up-down direction in the illustrated embodiment. In the illustrated embodiment, the second outlet housing inner circumference 232 is formed so that its inner diameter decreases in a direction opposite to the first outlet housing inner circumference 231, that is, in a direction from the upper side to the lower side.

The second outlet housing inner circumference 232 surrounds another part of the outlet housing nozzle space 240 in the height direction. In the illustrated embodiment, the second outlet housing inner circumference 232 radially surrounds the second outlet housing nozzle space 242 located below the first outlet housing nozzle space 241.

The second outlet housing inner circumference 232 is continuous with the third outlet housing inner circumference 233.

The third outlet housing inner circumference 233 constitutes yet another part of the inner circumference of the outlet housing nozzle 230. The third outlet housing inner circumference 233 is located between the second outlet housing inner circumference 232 and the fourth outlet housing inner circumference 234 along the height direction among the inner circumference of the outlet housing nozzle 230. In the illustrated embodiment, the third outlet housing inner circumference 233 is located below the second outlet housing inner circumference 232 and above the fourth outlet housing inner circumference 234.

The third outlet housing inner circumference 233 extends at a predetermined angle with the second outlet housing inner circumference 232. In an embodiment, the predetermined angle may be an obtuse angle. In the above embodiment, the third outlet housing inner circumference 233 may be formed to have a constant inner diameter along its height direction, that is, the up-down direction in the illustrated embodiment.

The third outlet housing inner circumference 233 surrounds yet another part of the outlet housing nozzle space 240 in the height direction. In the illustrated embodiment, the third outlet housing inner circumference 233 radially surrounds the third outlet housing nozzle space 243 located below the second outlet housing nozzle space 242.

The third outlet housing inner circumference 233 is continuous with the fourth outlet housing inner circumference 234.

The fourth outlet housing inner circumference 234 constitutes the remaining part of the inner circumference of the outlet housing nozzle 230. The fourth outlet housing inner circumference 234 constitutes the other side of the inner circumference of the outlet housing nozzle 230 in the height direction, that is, the lower side in the illustrated embodiment.

The fourth outlet housing inner circumference 234 extends at a predetermined angle with the third outlet housing inner circumference 233. In an embodiment, the predetermined angle may be an obtuse angle. In the above embodiment, the fourth outlet housing inner circumference 234 may be formed to have different inner diameters along its height direction, that is, the up-down direction in the illustrated embodiment. In the illustrated embodiment, the fourth outlet housing inner circumference 234 is formed so that its inner diameter decreases in a direction opposite to the third outlet housing inner circumference 233, that is, in a direction from the upper side to the lower side.

In this case, the fourth outlet housing inner circumference 234 may be formed in the shape of a curved surface with a predetermined curvature. The fourth outlet housing inner circumference 234 may be formed so that the angle formed between the tangent line and the central axis C is changed along its height direction. In the illustrated embodiment, the fourth outlet housing inner circumference 234 is formed to be round to be convex toward the central axis C.

In this case, the first contained angle a1 formed by the tangent line and the central axis C at one point located relatively above may be greater than the second contained angle a2 formed by the tangent line and the central axis C at another point located relatively below.

Therefore, due to the shape of the fourth outlet housing inner circumference 234, the sterilizing water discharged along the outlet housing nozzle space 240 does not flow in contact with the fourth outlet housing inner circumference 234. In other words, the discharged sterilizing water may be spaced apart from the fourth outlet housing inner circumference 234 at a specific point of the fourth outlet housing inner circumference 234 and discharged to the outside.

Therefore, the discharging angle of the sterilizing water discharged from the discharging nozzle assembly 10 is increased, so that the discharged sterilizing water may be discharged over a large area. At the same time, since the sterilizing water is spaced apart from the fourth outlet housing inner circumference 234 before being discharged, excessive expansion of the discharging area may be prevented. Consequently, the discharging and washing efficiency of the sterilizing water can be improved.

The outlet housing nozzle space 240 is a space formed inside the outlet housing nozzle 230. The outlet housing nozzle space 240 communicates with the outlet housing space 211 to provide a passage through which the sterilizing water passing through the vortex forming member 300 flows out. In addition, the outlet housing nozzle space 240 communicates with the outside to provide a passage through which the sterilizing water is discharged to the outside.

The outlet housing nozzle space 240 is formed inside the outlet housing nozzle 230. The outlet housing nozzle space 240 extends in the height direction of the outlet housing nozzle 230, i.e., in the up-down direction in the illustrated embodiment. One side of the outlet housing nozzle space 240 in the extension direction, that is, the upper side in the illustrated embodiment, is formed open to communicate with the outlet housing space 211. The other side in the extension direction of the outlet housing nozzle space 240, that is, the lower side in the illustrated embodiment, is formed open to communicate with the outside.

The outlet housing nozzle space 240 may be defined by being surrounded by the inner circumference of the outlet housing nozzle 230. In the illustrated embodiment, the radial outer side of the outlet housing nozzle space 240 is surrounded by the inner circumference of the outlet housing nozzle 230.

The outlet housing nozzle space 240 may have an arbitrary shape capable of communicating with the outlet housing space 211 and the outside, respectively, to form a discharging flow path of sterilizing water. In the illustrated embodiment, the outlet housing nozzle space 240 is formed as a three-dimensional figure shape space having a circular cross-section and a height in the up-down direction.

The outlet housing nozzle space 240 may be divided into a plurality of parts along the height direction thereof. The plurality of parts may be formed to be continuous with each other in the height direction of the outlet housing nozzle space 240, that is, in the up-down direction in the illustrated embodiment, but have different shapes.

In the illustrated embodiment, the outlet housing nozzle space 240 includes a first outlet housing nozzle space 241, a second outlet housing nozzle space 242, a third outlet housing nozzle space 243, and a fourth outlet housing nozzle space 244 (best shown in FIG. 9).

The first outlet housing nozzle space 241 constitutes a part of the outlet housing nozzle space 240. The first outlet housing nozzle space 241 is located on one side of the inner circumference of the outlet housing nozzle space 240 in the height direction, that is, on the upper side in the illustrated embodiment.

The first outlet housing nozzle space 241 is defined by being surrounded by the first outlet housing inner circumference 231. The first outlet housing nozzle space 241 may have a shape corresponding to the shape of the first outlet housing inner circumference 231. In the illustrated embodiment, the first outlet housing nozzle space 241 is formed as a cylindrical space having a circular cross-section and a height in the up-down direction. The first outlet housing inner circumference 231 may be formed to have a constant diameter along its height direction, that is, the up-down direction in the illustrated embodiment.

In the above embodiment, the diameter of the cross-section of the first outlet housing nozzle space 241 may be less than the diameter of the cross-section of a vortex base 330 provided in the vortex forming member 300. Accordingly, the vortex base 330 is supported by the lower inner surface of the outlet housing base 220, so that it does not arbitrarily enter the first outlet housing nozzle space 241.

The first outlet housing nozzle space 241 communicates with the second outlet housing nozzle space 242.

The second outlet housing nozzle space 242 constitutes another part of the outlet housing nozzle space 240. The second outlet housing nozzle space 242 is located between the first outlet housing nozzle space 241 and the third outlet housing nozzle space 243 along its height direction. In the illustrated embodiment, the second outlet housing nozzle space 242 is located below the first outlet housing nozzle space 241 and above the third outlet housing nozzle space 243.

The second outlet housing nozzle space 242 is defined by being surrounded by the second outlet housing inner circumference 232. The second outlet housing nozzle space 242 may have a shape corresponding to the shape of the second outlet housing inner circumference 232. In the illustrated embodiment, the second outlet housing nozzle space 242 is formed as a concave space having a circular cross-section and decreasing the diameter of the cross-section thereof along the height direction.

In the above embodiment, the diameter of the cross-section of the upper end of the second outlet housing nozzle space 242 may be the same as the diameter of the cross-section of the first outlet housing nozzle space 241. In addition, the diameter of the cross-section of the lower end of the second outlet housing nozzle space 242 may be the same as the diameter of the cross-section of the third outlet housing nozzle space 243.

In the above embodiment, as the diameter of the cross-section of the second outlet housing nozzle space 242 decreases in an outward direction, the flow rate of sterilizing water flowing in the second outlet housing nozzle space 242 may increase.

The second outlet housing nozzle space 242 communicates with the third outlet housing nozzle space 243.

The third outlet housing nozzle space 243 constitutes yet another part of the outlet housing nozzle space 240. The third outlet housing nozzle space 243 is located between the second outlet housing nozzle space 242 and the fourth outlet housing nozzle space 244 along its height direction. In the illustrated embodiment, the third outlet housing nozzle space 243 is located below the second outlet housing nozzle space 242 and above the fourth outlet housing nozzle space 244.

The third outlet housing nozzle space 243 is defined by being surrounded by the third outlet housing inner circumference 233. The third outlet housing nozzle space 243 may have a shape corresponding to the shape of the third outlet housing inner circumference 233. In the illustrated embodiment, the third outlet housing nozzle space 243 is formed as a cylindrical space having a circular cross-section and a height in the up-down direction. The third outlet housing inner circumference 233 may be formed to have a constant diameter along its height direction, that is, the up-down direction in the illustrated embodiment.

In the above embodiment, it will be understood that the diameter of the cross-section of the third outlet housing nozzle space 243 is less than the diameter of the cross-section of the first outlet housing nozzle space 241.

The third outlet housing nozzle space 243 communicates with the fourth outlet housing nozzle space 244.

The fourth outlet housing nozzle space 244 constitutes the remaining part of the outlet housing nozzle space 240. The fourth outlet housing nozzle space 244 is located below the third outlet housing nozzle space 243 along its height direction.

The fourth outlet housing nozzle space 244 is defined by being surrounded by the fourth outlet housing inner circumference 234. The fourth outlet housing nozzle space 244 may have a shape corresponding to the shape of the fourth outlet housing inner circumference 234. In the illustrated embodiment, the fourth outlet housing nozzle space 244 is a truncated pyramid-shaped space having a side surface of an inwardly convex curved shape and a height in the up-down direction.

In the above embodiment, the diameter of the cross-section of the fourth outlet housing nozzle space 244 may be reduced in a direction opposite to the third outlet housing nozzle space 243, that is, from the upper side to the lower side in the illustrated embodiment. In this case, the diameter of the cross-section of the fourth outlet housing nozzle space 244 may non-linearly change along the height direction thereof.

Therefore, as described above, the sterilizing water passing through the first to fourth outlet housing nozzle spaces 241, 242, 243, and 244 may be separated from the inner circumference of the outlet housing nozzle 230 by the shape of the fourth outlet housing inner circumference 234 and discharged to the outside.

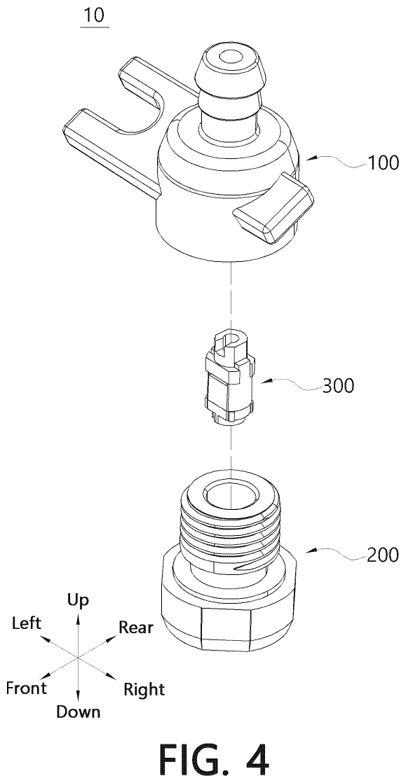

Referring back to FIG. 4, the discharging nozzle assembly 10 according to an exemplary embodiment of the present invention includes a vortex forming member 300.

The vortex forming member 300 is partially accommodated in the inlet housing 100 and the outlet housing 200, respectively. The vortex forming member 300 communicates with the inlet housing 100 and the outlet housing 200. The sterilizing water introduced from the tank device 20 may pass through the inlet housing 100 and the vortex forming member 300 and be discharged toward a bowl (not shown) through the outlet housing 200.

The vortex forming member 300 may be supported by the inlet housing 100 and the outlet housing 200. That is, the vortex forming member 300 may not be structurally coupled to the inlet housing 100 and the outlet housing 200, and may be supported by the inlet housing 100 and the outlet housing 200 at least one point.

Therefore, an additional process for coupling the vortex forming member 300 with the inlet housing 100 or the outlet housing 200 is not required. As a result, the manufacturing efficiency of the discharging nozzle assembly 10 can be improved.

The vortex forming member 300 is inside the inlet housing 100 and the outlet housing 200. Specifically, a part of the vortex forming member 300 is accommodated in the inlet housing space 111, and another part thereof is accommodated in the outlet housing space 211. The vortex forming member 300 is not arbitrarily exposed to the outside of the inlet housing 100 or the outlet housing 200.

As described above, the vortex forming member 300 may be supported by the inlet housing 100 and the outlet housing 200. Specifically, each side of the vortex forming member 300 in the height direction may be supported by the support end 122, and the upper inner surface of the outlet housing base 220. In addition, the radial direction of the vortex forming member 300 may be supported by the inner circumferential surface of the outlet housing body 210, that is, the surface surrounding the outlet housing space 211 in the radial direction.

The vortex forming member 300 may have a shape corresponding to the shape of the inlet housing 100 or the outlet housing 200. In the illustrated embodiment, the vortex forming member 300 is formed to have a circular cross-section and a height in the up-down direction. In this case, the diameter of the cross-section of the vortex forming member 300 may be less than or equal to the diameter of the cross-section of the inlet housing space 111 or the outlet housing space 211. In addition, the length of the vortex forming member 300 in the height direction may be less than or equal to the height of the outlet housing space 211.

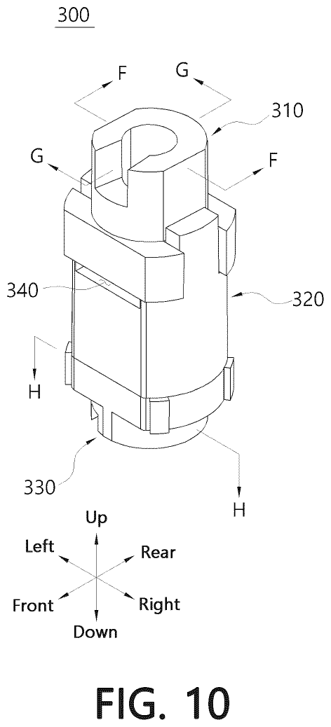

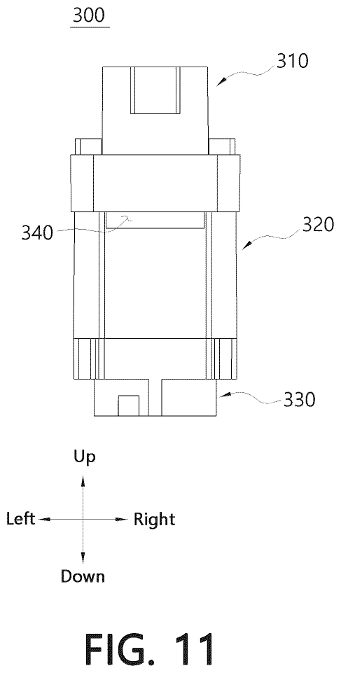

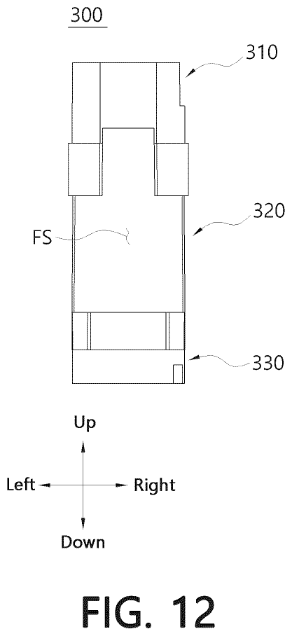

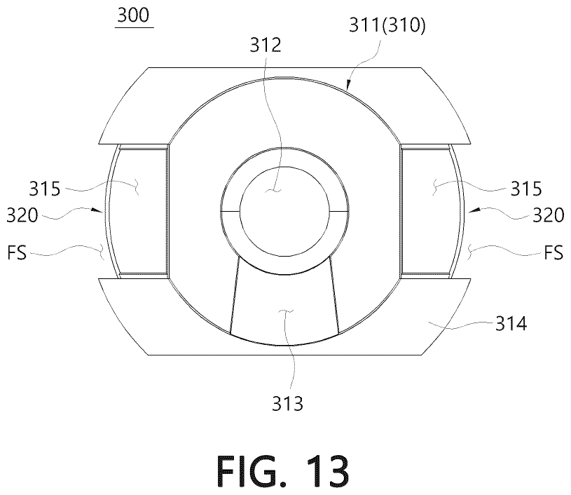

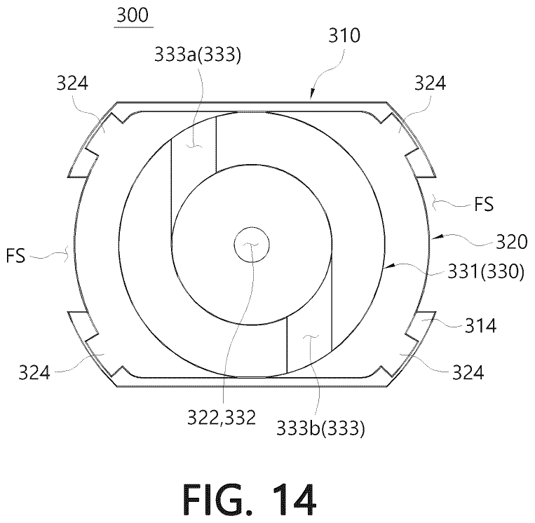

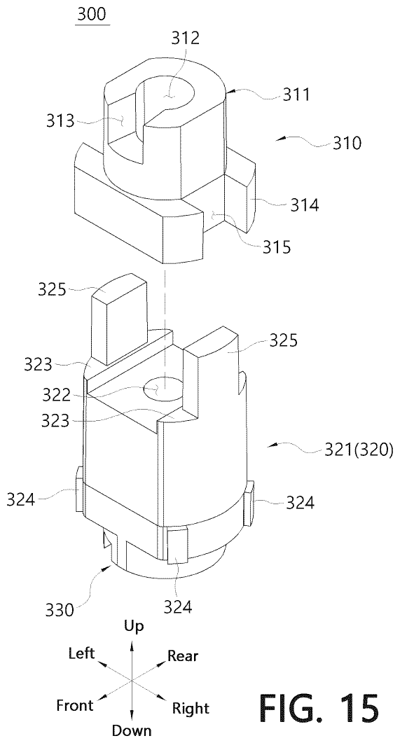

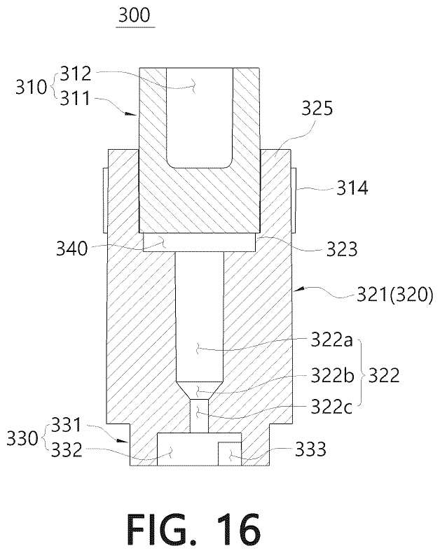

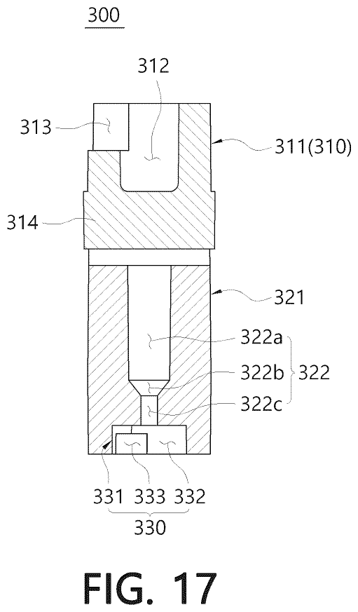

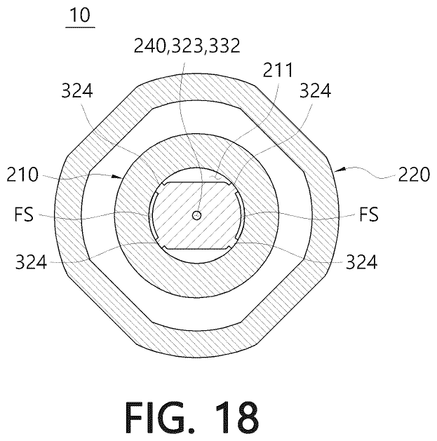

In an embodiment shown in FIGS. 10 to 18, the vortex forming member 300 includes an inlet vortex housing 310, an outlet vortex housing 320, a vortex base 330, and a vortex communication opening 340.

The inlet vortex housing 310 constitutes a part of the outer shape of the vortex forming member 300. The inlet vortex housing 310 constitutes one side in the height direction of the vortex forming member 300, that is, the upper side in the illustrated embodiment.

One side of the inlet vortex housing 310 in the height direction is supported by the inlet housing 100. That is, one side of the inlet vortex housing 310 in the height direction, that is, the upper side in the illustrated embodiment, may be supported in the height direction by the support end 122.

The inlet vortex housing 310 communicates with the inlet housing 100. Specifically, a hollow formed inside the inlet vortex housing 310 (i.e., an inlet vortex hollow 312 to be described later) is fluidly connected to the inlet hollow 121. As will be described later, the sterilizing water introduced along the inlet hollow 121 may proceed after necessarily passing through the inlet vortex hollow 312.

The inlet vortex housing 310 is coupled to the outlet vortex housing 320. In this case, the inlet vortex housing 310 may be connected to the outlet vortex housing 320 in a way that it can be lifted and lowered but cannot be rotated. In the above embodiment, the inlet vortex housing 310 may be seated in the outlet vortex housing 320. Therefore, in the above embodiment, it will be understood that the upper side of the inlet vortex housing 310 is supported by the support end 122 and the lower side thereof is supported by the outlet vortex housing 320.

Alternatively, the inlet vortex housing 310 may be integrally formed with the outlet vortex housing 320.

In this case, the inlet vortex housing 310 may be blocked from direct communication with the outlet vortex housing 320, but indirect communication may be allowed. That is, the sterilizing water introduced into the inlet vortex housing 310 does not flow directly into the outlet vortex housing 320, but may be introduced into the outlet vortex housing 320 after passing through the outlet housing space 211.

In the illustrated embodiment, the inlet vortex housing 310 includes an inlet vortex housing body 311, an inlet vortex hollow 312, an inlet vortex opening 313, an inlet vortex rib 314, and an inlet vortex coupling space 315.

The inlet vortex housing body 311 constitutes a part of the inlet vortex housing 310. The inlet vortex housing body 311 is a part where the inlet vortex housing 310 is in contact with and supported by the support end 122. In the illustrated embodiment, the inlet vortex housing body 311 constitutes one side in the height direction, that is, the upper side, of the inlet vortex housing 310.

The inlet vortex housing body 311 is accommodated in the outlet housing space 211. In this case, the inlet vortex housing body 311 may be disposed to be spaced apart from the inner circumferential surface of the outlet housing body 210 surrounding the outlet housing space 211. Therefore, a space through which sterilizing water may flow may be formed between the outer circumferential surface of the inlet vortex housing body 311 and the inner circumferential surface of the outlet housing body 210.

The inlet vortex hollow 312 is formed inside the inlet vortex housing body 311. In addition, the inlet vortex opening 313 is formed on one side of each side of the inlet vortex housing body 311 in the horizontal direction, that is, on the front side in the illustrated embodiment.

The inlet vortex housing body 311 is continuous with the inlet vortex rib 314. Furthermore, the inlet vortex housing body 311 partially surrounds the inlet vortex coupling space 315 radially inward.

The inlet vortex housing body 311 may have any shape that can be supported by the support end 122 and an outlet vortex housing body 321 and communicate with the inlet hollow 121.

In the illustrated embodiment, the inlet vortex housing body 311 includes a pair of planes facing each other and extending in the front-rear direction, and a pair of curved surfaces continuous with the pair of planes, facing each other, extending in the left-right direction, and rounded to be convex toward the outside.

In this case, the inlet vortex hollow 312 is formed recessed inside the inlet vortex housing body 311. In addition, on one of the pair of curved surfaces of the components of the inlet vortex housing body 311, that is, on the front side in the illustrated embodiment, the inlet vortex opening 313 is formed recessed to communicate the outlet housing space 211 with the inlet vortex hollow 312.

The inlet vortex hollow 312 may be defined as a space formed inside the inlet vortex housing body 311. The inlet vortex hollow 312 is formed recessed on one side in the height direction of the inlet vortex housing body 311, that is, on the upper side in the illustrated embodiment.

The inlet vortex hollow 312 extends in the height direction of the inlet vortex housing body 311, i.e., in the up-down direction in the illustrated embodiment. One side of the inlet vortex hollow 312 in the height direction, that is, the upper side in the illustrated embodiment, is formed open to communicate with the inlet hollow 121.

In this case, the upper surfaces of the support end 122 and the inlet vortex housing body 311 may be tightly coupled to each other. Accordingly, all sterilizing water introduced into the inlet hollow 121 may only be introduced into the inlet vortex hollow 312.

The other side in the height direction of the inlet vortex hollow 312, that is, the lower side in the illustrated embodiment, is closed. Therefore, the sterilizing water introduced into the inlet vortex hollow 312 does not flow directly into the outlet vortex housing 320.

The horizontal direction of the inlet vortex hollow 312 is surrounded by the inner circumference of the inlet vortex housing body 311. In this case, one side in the horizontal direction of the inlet vortex hollow 312, i.e., the front side in the illustrated embodiment, is opened by the inlet vortex opening 313. The inlet vortex hollow 312 may communicate with the outlet housing space 211 through the inlet vortex opening 313.

The inlet vortex hollow 312 may have a shape corresponding to the shape of the inlet hollow 121. In the illustrated embodiment, the inlet vortex hollow 312 is formed as a cylindrical space having a circular cross-section and a height in the up-down direction.

The inlet vortex opening 313 communicates the inlet vortex hollow 312 with the outlet housing space 211. The sterilizing water introduced into the inlet vortex hollow 312 through the inlet hollow 121 may flow into the outlet housing space 211 through the inlet vortex opening 313.

The inlet vortex opening 313 is formed recessed in one surface in the horizontal direction of the inlet vortex housing body 311. In the illustrated embodiment, the inlet vortex opening 313 is formed recessed in a curved surface located in the front side of the surface of the inlet vortex housing body 311.

The inlet vortex opening 313 may be formed at any location capable of communicating the inlet vortex hollow 312 with the outlet housing space 211. However, it is preferable that the inlet vortex opening 313 is formed corresponding to the position of the plane part (i.e., the front and rear side surfaces in the illustrated embodiment) of the surface of the outlet vortex housing body 321 to be described later.

As will be described later, this is because the space formed by the plane part of the surface of the outlet vortex housing body 321 being spaced apart from the inner surface of the outlet housing body 210 is formed larger than the space formed by the curved surface part being spaced apart from the inner surface of the outlet housing body 210, so that the sterilizing water can flow more smoothly.

In this case, the inlet vortex opening 313 may be formed to have an increased cross-sectional area along a direction opposite to the inlet vortex hollow 312, that is, a direction from the rear side to the front side in the illustrated embodiment.

In addition, in the illustrated embodiment, a single inlet vortex opening 313 is formed. Alternatively, a plurality of inlet vortex openings 313 may be formed. Also in the above embodiment, the plurality of inlet vortex openings 313 may be disposed corresponding to positions of a plane part of the surface of the outlet vortex housing body 321.

The inlet vortex rib 314 is a part in which the inlet vortex housing 310 is supported in the radial direction by the inner circumference of the outlet housing body 210. The inlet vortex rib 314 may be formed to extend toward the horizontal outer side of the inlet vortex housing body 311 and may be in contact with the inner circumferential surface of the outlet housing body 210. The inlet vortex rib 314 extends outward from the outer circumference of the inlet vortex housing body 311.

In an embodiment, the inlet vortex rib 314 may be disposed to be spaced apart from the inner circumferential surface of the outlet housing body 210. In the above embodiment, the inlet vortex housing 310 may be moved by a predetermined distance in the horizontal direction. Even in this case, it is preferable that the inlet hollow 121 communicates only with the inlet vortex hollow 312.

The shape of the inlet vortex rib 314 may be formed to correspond to the shape of the inner circumference of the outlet housing body 210. In the illustrated embodiment, the end of the inlet vortex rib 314 is formed to be inclined to correspond to the shape of the inner circumference of the outlet housing body 210 formed to have a circular cross-section.

By the inlet vortex rib 314, the inlet vortex housing 310 may be maintained such that its center is located at the center of the outlet housing space 211. Accordingly, the central axis between the inlet hollow 121 and the inlet vortex hollow 312 may also be maintained to coincide.

A plurality of inlet vortex ribs 314 may be provided. The plurality of inlet vortex ribs 314 may be in contact with the inner circumference of the outlet housing body 210 at different positions, respectively. In the illustrated embodiment, four inlet vortex ribs 314 are provided. A pair of inlet vortex ribs 314 are located on the front side of the inlet vortex housing body 311. The other pair of inlet vortex ribs 314 are located on the rear side of the inlet vortex housing body 311.

In this case, the pair of inlet vortex ribs 314 may be disposed to be spaced apart from the other pair of inlet vortex ribs 314 along the front-rear direction. Accordingly, a space is formed between the pair of inlet vortex ribs 314 and the other pair of inlet vortex ribs 314. The space may be defined as an inlet vortex coupling space 315.

The inlet vortex coupling space 315 is a part where the inlet vortex housing 310 is coupled to the outlet vortex housing 320. The inlet vortex coupling space 315 accommodates one component of the outlet vortex housing 320, that is, an outlet vortex coupling extension 325 to be described later.

The inlet vortex coupling space 315 is defined by the inlet vortex housing body 311 and the inlet vortex rib 314. Specifically, both sides of the inlet vortex coupling space 315 in the horizontal direction, i.e., the front and rear sides in the illustrated embodiment, are surrounded by the inlet vortex rib 314.

Another side of the inlet vortex coupling space 315 in the horizontal direction, i.e., the left or right side in the illustrated embodiment, is surrounded by the inlet vortex housing body 311. The other side of the inlet vortex coupling space 315 in the horizontal direction, i.e., the right or left side in the illustrated embodiment, is formed open.

The inlet vortex coupling space 315 may have a shape corresponding to the shape of the outlet vortex coupling extension 325. In the illustrated embodiment, the inlet vortex coupling space 315 is formed as a three-dimensional figure shape having a height in the up-down direction with a front side and a rear side as a plane, a left or right side as a curved surface, and a right or left side formed open.

The outlet vortex coupling extension 325 accommodated in the inlet vortex coupling space 315 may be supported by being surrounded by the inlet vortex housing body 311 and the inlet vortex rib 314.

A plurality of inlet vortex coupling spaces 315 may be formed. The plurality of inlet vortex coupling spaces 315 are disposed to be spaced apart from each other in the width direction of the inlet vortex housing 310, that is, in the left-right direction in the illustrated embodiment, to accommodate a plurality of outlet vortex coupling extensions 325, respectively. In the illustrated embodiment, a pair of inlet vortex coupling spaces 315 are provided, and are located on the left and right sides of the inlet vortex housing body 311, respectively.

The number, shape, and arrangement method of the inlet vortex coupling spaces 315 may be changed according to the number, shape, and arrangement method of the outlet vortex coupling extensions 325.

The outlet vortex housing 320 constitutes another part of the outer shape of the vortex forming member 300. The outlet vortex housing 320 constitutes the other side in the height direction of the vortex forming member 300, that is, the intermediate part in the illustrated embodiment.

The outlet vortex housing 320 is coupled to the inlet vortex housing 310. The outlet vortex housing 320 may be detachably in the up-down direction but non-rotatably coupled to the inlet vortex housing 310. As described above, the outlet vortex housing 320 may be integrally formed with the inlet vortex housing 310. The outlet vortex housing 320 supports the inlet vortex housing 310 from the lower side.

The outlet vortex housing 320 is continuous with the vortex base 330. The outlet vortex housing 320 may be supported on the upper surface (or the lower inner surface of the outlet housing body 210) of the outlet housing base 220 by the vortex base 330.

The outlet vortex housing 320 communicates with the outlet housing space 211. The sterilizing water introduced into the outlet housing space 211 may be introduced into the outlet vortex housing 320. As described above, the outlet vortex housing 320 indirectly communicates with the inlet vortex housing 310 through the outlet housing space 211, but direct communication with the inlet vortex housing 310 may be blocked.

In the illustrated embodiment, the outlet vortex housing 320 includes an outlet vortex housing body 321, an outlet vortex hollow 322, an outlet vortex support protrusion 323, an outlet vortex rib 324, and an outlet vortex coupling extension 325.

The outlet vortex housing body 321 constitutes a part of the outlet vortex housing 320. Another component of the outlet vortex housing 320 is disposed in the outlet vortex housing body 321.

The outlet vortex housing body 321 is accommodated in the outlet housing space 211. In this case, the outlet vortex housing body 321 may be disposed to be spaced apart from the inner circumferential surface of the outlet housing body 210 surrounding the outlet housing space 211. Therefore, a space through which sterilizing water may flow may be formed between the outer circumferential surface of the outlet vortex housing body 321 and the inner circumferential surface of the outlet housing body 210.

The outlet vortex hollow 322 is formed inside the outlet vortex housing body 321. In addition, the outlet vortex support protrusion 323 and the outlet vortex coupling extension 325 are located on one side of the outlet vortex housing body 321 in the height direction, that is, on the upper side in the illustrated embodiment. In addition, the outlet vortex rib 324 is formed on the outer circumference of the outlet vortex housing body 321.

The outlet vortex housing body 321 may have any shape in which other components of the outlet vortex housing 320 may be disposed. In the illustrated embodiment, the outlet vortex housing body 321 includes a pair of planes facing each other and extending in the front-rear direction, and a pair of curved surfaces continuous with the pair of planes, facing each other, extending in the left-right direction, and rounded to be convex toward the outside.

In this case, a space formed by separating the pair of curved surfaces of the outlet vortex housing body 321 and the inner circumferential surface of the outlet housing body 210 may be defined as a flow space FS. The sterilizing water passing through the inlet vortex housing 310 may flow in the flow space FS and enter the vortex base 330. This will be described later in detail.

The outlet vortex hollow 322 may be defined as a space formed inside the outlet vortex housing body 321. The outlet vortex hollow 322 is formed inside the outlet vortex housing body 321. The outlet vortex hollow 322 is defined by being surrounded by the inner circumference of the outlet vortex housing body 321.

The outlet vortex hollow 322 extends in the height direction of the outlet vortex housing body 321, i.e., in the up-down direction in the illustrated embodiment. Each end in the extension direction of the outlet vortex hollow 322 is formed open, respectively. One end of the outlet vortex hollow 322 in the extension direction, i.e., the upper end in the illustrated embodiment, communicates with the outlet housing space 211 through the vortex communication opening 340. The other end of the outlet vortex hollow 322 in the extension direction, i.e., the lower end in the illustrated embodiment, communicates with a vortex base hollow 332 formed inside the vortex base 330.

Accordingly, a portion of the sterilizing water flowing in the outlet housing space 211 may pass through the vortex communication opening 340 and the outlet vortex hollow 322 to enter the vortex base hollow 332.

As the outlet vortex hollow 322 is formed, a portion of the sterilizing water may flow in the vertical direction to enter the vortex base hollow 332. The portion of the sterilizing water may function as a center of the discharged vortex. Accordingly, the sterilizing water can be discharged in the form of a stable vortex.

In addition, by the portion of the sterilizing water, the straightness and dischargeability of the discharged sterilizing water can be improved, and the back pressure can also increase. Accordingly, the cleaning or sterilization effect by the sterilizing water discharged from the discharging nozzle assembly 10 can be improved.

The outlet vortex hollow 322 may be of any shape capable of communicating with the vortex communication opening 340 and the vortex base hollow 332. In the illustrated embodiment, the outlet vortex hollow 322 is formed as a cylindrical space having a circular cross-section and a height in the up-down direction. In the above embodiment, the outlet vortex hollow 322 may be formed to have the same central axis as the inlet hollow 121 or the inlet vortex hollow 312.

Meanwhile, the outlet vortex hollow 322 may be formed to have a shape changed along the height direction thereof. Accordingly, the flow rate of the sterilizing water flowing along the outlet vortex hollow 322 increases in a direction toward the vortex base hollow 332, so that smooth discharging can be performed.

In the illustrated embodiment, the outlet vortex hollow 322 includes a first outlet vortex hollow 322a, a second outlet vortex hollow 322b, and a third outlet vortex hollow 322c.

The first outlet vortex hollow 322a constitutes one side in the height direction of the outlet vortex hollow 322, that is, the upper side in the illustrated embodiment. The first outlet vortex hollow 322a extends in the height direction of the outlet vortex housing body 321, i.e., in the up-down direction in the illustrated embodiment.

The upper end of the first outlet vortex hollow 322a is open to communicate with the vortex communication opening 340. The lower end of the first outlet vortex hollow 322a is open to communicate with the second outlet vortex hollow 322b. The first outlet vortex hollow 322a may be formed to have the same diameter along the height direction thereof.

The second outlet vortex hollow 322b constitutes the other side in the height direction of the outlet vortex hollow 322, that is, the intermediate part in the illustrated embodiment. The second outlet vortex hollow 322b extends in the height direction of the outlet vortex housing body 321, i.e., in the up-down direction in the illustrated embodiment.

The upper end of the second outlet vortex hollow 322b is open to communicate with the first outlet vortex hollow 322a. The lower end of the second outlet vortex hollow 322b is open to communicate with the third outlet vortex hollow 322c.

The second outlet vortex hollow 322b may be formed to have different diameters along the height direction thereof. In an embodiment, the second outlet vortex hollow 322b may be formed so that its cross-sectional area decreases along a direction opposite to the first outlet vortex hollow 322a, that is, a direction from the upper side to the lower side. In the illustrated embodiment, the second outlet vortex hollow 322b has a concave shape in which a cross-sectional area of the upper end is larger than that of the lower end.

Accordingly, the flow rate of the sterilizing water passing through the second outlet vortex hollow 322b can be increased.

The third outlet vortex hollow 322c constitutes the remaining part in the height direction of the outlet vortex hollow 322, that is, the lower side in the illustrated embodiment. The third outlet vortex hollow 322c extends in the height direction of the outlet vortex housing body 321, i.e., in the up-down direction in the illustrated embodiment.

The upper end of the third outlet vortex hollow 322c is open to communicate with the second outlet vortex hollow 322b. The lower end of the third outlet vortex hollow 322c is open to communicate with the vortex base hollow 332.

The third outlet vortex hollow 322c may be formed to have the same diameter along the height direction thereof. In the illustrated embodiment, the third outlet vortex hollow 322c may be formed to have the same diameter as the lower end of the second outlet vortex hollow 322b. In this case, the diameter of the cross-section of the third outlet vortex hollow 322c may be less than the diameter of the cross-section of the first outlet vortex hollow 322a.

Therefore, it will be understood that the flow rate of sterilizing water flowing along the first to third outlet vortex hollows 322a, 322b, and 322c may gradually increase.

The outlet vortex support protrusion 323 is a part where the outlet vortex housing 320 supports the inlet vortex housing 310. The outlet vortex support protrusion 323 is located on one side of the outlet vortex housing body 321 in the height direction, i.e., at the upper end in the illustrated embodiment.

The outlet vortex support protrusion 323 may extend along the outer circumference of the outlet vortex housing body 321. In the illustrated embodiment, the outlet vortex support protrusion 323 extends along a portion formed as a curved surface of the outlet vortex housing body 321.

The outlet vortex support protrusion 323 may protrude from the outlet vortex housing body 321 by a predetermined height. Accordingly, the remaining portion of the upper surface of the outlet vortex housing body 321 on which the outlet vortex support protrusion 323 is not formed may be spaced apart from the lower end of the inlet vortex housing body 311. The vortex communication opening 340 may be defined by the separation.

A plurality of outlet vortex support protrusions 323 may be provided. The plurality of outlet vortex support protrusions 323 may be disposed at different positions to support different parts of the inlet vortex housing body 311, respectively. In the illustrated embodiment, a pair of outlet vortex support protrusions 323 are provided, and are located on the left and right sides, respectively.

The outlet vortex rib 324 protrudes from the outer circumference of the outlet vortex housing body 321. As the outlet vortex rib 324 is formed, the outer circumferential surface of the outlet vortex housing body 321 and the inner surface of the outlet housing body 210 may be spaced apart from each other to define a flow space FS.

That is, the outlet vortex rib 324 is configured to prevent contact between the outer circumferential surface of the outlet vortex housing body 321 and the inner surface of the outlet housing body 210. To this end, the outlet vortex rib 324 may protrude in a radial direction of the outlet vortex housing body 321.

The outlet vortex rib 324 is positioned to be biased to one side in the height direction of the outlet vortex housing body 321. In the illustrated embodiment, the outlet vortex rib 324 is located on one side, that is, the lower side, of the outlet vortex housing body 321 facing the vortex base 330.

By the outlet vortex rib 324, the outlet vortex housing 320 may be maintained such that its center is located at the center of the outlet housing space 211. Accordingly, the central axis between the outlet vortex hollow 322, the vortex base hollow 332 and the outlet housing nozzle space 240 can also be maintained to be aligned.

A plurality of outlet vortex ribs 324 may be provided. The plurality of outlet vortex ribs 324 may be spaced apart from each other along the outer circumferential direction of the outlet vortex housing body 321, respectively, to prevent contact between the inner circumferential surface of the outlet housing body 210 and the outer surface of the outlet vortex housing body 321.

In the illustrated embodiment, four outlet vortex ribs 324 are provided, and are disposed on the left and right sides of the front and the left and right sides of the rear, respectively.

The outlet vortex coupling extension 325 is a part where the outlet vortex housing 320 is coupled to the inlet vortex housing 310. The outlet vortex coupling extension 325 is located on one side of the outlet vortex housing body 321 in the height direction, i.e., at the upper side in the illustrated embodiment. The outlet vortex coupling extension 325 is formed to extend in a direction from the upper side of the outlet vortex support protrusion 323 toward the inlet vortex housing 310, that is, upward in the illustrated embodiment.

The outlet vortex coupling extension 325 is accommodated in the inlet vortex coupling space 315. In an embodiment in which the inlet vortex housing 310 and the outlet vortex housing 320 are detachably coupled, the outlet vortex coupling extension 325 may be retractably accommodated in the inlet vortex coupling space 315.

As the outlet vortex coupling extension 325 is accommodated in the inlet vortex coupling space 315, a relative rotation between the inlet vortex housing 310 and the outlet vortex housing 320 may be limited.

A plurality of outlet vortex coupling extensions 325 may be provided. The plurality of outlet vortex coupling extensions 325 may be accommodated in a plurality of inlet vortex coupling spaces 315, respectively, at different positions. In the illustrated embodiment, a pair of outlet vortex coupling extensions 325 are provided and are accommodated in a pair of inlet vortex coupling spaces 315, respectively.

The shape, number, and arrangement method of the outlet vortex coupling extensions 325 may be changed according to the shape, number, and arrangement method of the inlet vortex coupling spaces 315.

The vortex base 330 substantially serves to form a flow of sterilizing water discharged from the discharging nozzle assembly 10 into a vortex. The sterilizing water introduced into the discharging nozzle assembly 10 may necessarily pass through the vortex base 330 and then be discharged to the outside through the outlet housing nozzle 230.

Therefore, it may be said that the vortex base 330 is disposed on the most downstream side of the configuration of the vortex forming member 300.

The vortex base 330 is accommodated in the outlet housing space 211. The vortex base 330 is seated and supported on the lower inner surface of the outlet housing body 210 (or the upper surface of the outlet housing base 220) surrounding the outlet housing space 211 on one side in the height direction, that is, on the lower side in the illustrated embodiment.

The vortex base 330 communicates with the outlet housing space 211. The sterilizing water introduced into the outlet housing space 211 may flow out into the vortex base 330.

The vortex base 330 is coupled to the outlet vortex housing 320. In an embodiment the vortex base 330 may be integrally formed with the outlet vortex housing 320. The vortex base 330 communicates with the outlet vortex housing 320. The sterilizing water introduced into the outlet vortex housing 320 may flow out into the vortex base 330.

The vortex base 330 communicates with the outlet housing nozzle 230. The sterilizing water introduced into the vortex base 330 may flow out into the outlet housing nozzle 230. The vortex base 330 may be disposed to overlap the outlet housing nozzle 230 along the height direction to cover the outlet housing nozzle 230.

In the illustrated embodiment, the vortex base 330 includes a vortex base body 331, a vortex base hollow 332, and a vortex base inlet 333.

The vortex base body 331 constitutes the outer shape of the vortex base 330. The vortex base body 331 is a part where the vortex base 330 is coupled to the outlet vortex housing 320. In addition, the vortex base body 331 covers the outlet housing nozzle 230 and is seated on the lower inner surface of the outlet housing body 210 (or the upper surface of the outlet housing base 220).

The vortex base body 331 may have a shape corresponding to the shape of the outlet vortex housing body 321. In this case, the vortex base body 331 may be formed to have a cross-sectional area smaller than that of the outlet vortex housing body 321. In the illustrated embodiment, the vortex base body 331 has a disk shape having a circular cross-section and having a height in the up-down direction. In this case, the diameter of the cross-section of the vortex base body 331 may be formed to be less than or equal to the diameter of the cross-section of the outlet vortex housing body 321.

Therefore, sufficient space for sterilizing water to flow can be secured in a portion of the outlet housing space 211 where the vortex base body 331 is located.

The vortex base hollow 332 is formed inside the vortex base body 331.

The vortex base hollow 332 is a part where the vortex base 330 communicates with the outlet housing space 211, the outlet vortex hollow 322, and the outlet housing nozzle space 240. The vortex base hollow 332 may be defined as a space formed inside the vortex base 330.

The radial direction of the vortex base hollow 332 may be surrounded by the inner circumference of the vortex base body 331. In this case, the vortex base hollow 332 may communicate with the outlet housing space 211 in the radial direction by the vortex base inlet 333 formed recessed in the radial direction in the vortex base body 331.

The upper side of the vortex base hollow 332 may be surrounded by the upper inner surface of the vortex base body 331. In this case, the upper side of the vortex base hollow 332 communicates with the third outlet vortex hollow 322c, so that the sterilizing water flowing along the outlet vortex hollow 322 may be introduced into the vortex base hollow 332.

The lower side of the vortex base hollow 332 is formed open to communicate with the first outlet housing nozzle space 241. The sterilizing water introduced into the vortex base hollow 332 may pass through the outlet housing nozzle space 240 to be discharged to the outside.

The vortex base hollow 332 may have a shape corresponding to the shape of the vortex base body 331. In the illustrated embodiment, the vortex base hollow 332 has a disk shape having a circular cross-section and having a height in the up-down direction. In this case, the diameter of the cross-section of the vortex base hollow 332 may be less than or equal to the diameter of the cross-section of the first outlet housing nozzle space 241.

The vortex base inlet 333 communicates the vortex base hollow 332 with the outlet housing space 211. The vortex base inlet 333 is formed through the outer circumference of the vortex base body 331 radially surrounding the vortex base hollow 332 in the radial direction.

The vortex base inlet 333 may be disposed to be eccentric with respect to the center of the vortex base hollow 332. Accordingly, the sterilizing water introduced into the vortex base inlet 333 may flow out into the outlet housing nozzle space 240 having the same axial center as the vortex base hollow 332 in the form of a vortex.

The vortex base inlet 333 may form a predetermined angle with respect to the diameter direction of the vortex base hollow 332. In the illustrated embodiment, the vortex base inlet 333 extends in the front-rear direction. The outer end of the vortex base inlet 333 communicates with the outlet housing space 211. The inner end of the vortex base inlet 333 communicates with the vortex base hollow 332.

As the vortex base inlet 333 extends at a predetermined angle with respect to the diameter direction of the vortex base hollow 332, the sterilizing water introduced into the vortex base hollow 332 from the outlet housing space 211 may flow in the form of a vortex.

In this case, the vortex base inlet 333 may have a sufficiently large width. Specifically, it is preferable that the vortex base inlet 333 is formed large enough to allow the generated sterilizing water to flow smoothly. For example, the vortex base inlet 333 may be formed large enough to allow sterilizing water with large particles to flow smoothly enough to require additional configuration such as a pump for its flow.

A plurality of vortex base inlets 333 may be provided. The plurality of vortex base inlets 333 may be disposed at different positions to communicate with the outlet housing space 211 and the vortex base hollow 332, respectively. In the illustrated embodiment, the vortex base inlet 333 is provided as a pair, including a first vortex base inlet 333a and a second vortex base inlet 333b.

The first vortex base inlet 333a is located on the front left side to communicate the outlet housing space 211 with the vortex base hollow 332. The second vortex base inlet 333b is located on the rear right side to communicate the outlet housing space 211 with the vortex base hollow 332.

The vortex communication opening 340 is a space formed between the inlet vortex housing 310 and the outlet vortex housing 320. The vortex communication opening 340 may be defined such that a portion of the inlet vortex housing 310 is spaced apart from a portion of the outlet vortex housing 320.

As described above, the vortex communication opening 340 may be formed to be spaced apart from the upper side of the outlet vortex housing body 321 as the lower side of the inlet vortex housing body 311 is seated on the outlet vortex support protrusion 323.

The vortex communication opening 340 forms a flow path through which a part of the sterilizing water introduced into the outlet housing space 211 through the inlet vortex hollow 312 and the inlet vortex opening 313 is introduced into the outlet vortex hollow 322. The vortex communication opening 340 communicates with the outlet housing space 211 and the outlet vortex hollow 322, respectively.

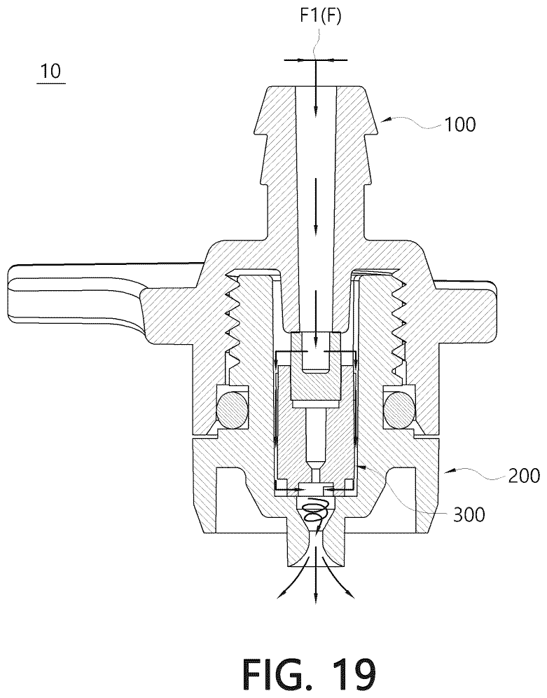

Referring to FIGS. 19 to 21, a flow F of sterilizing water formed in the discharging nozzle assembly 10 according to an exemplary embodiment of the present invention is illustrated as an example.

Referring to FIG. 19, a first flow F1 of sterilizing water formed in the discharging nozzle assembly 10 according to an exemplary embodiment of the present invention is illustrated as an example. The first flow F1 may be defined as a flow in which the introduced sterilizing water does not pass through the outlet vortex housing 320 and is discharged to the outside through the vortex base 330.

First, sterilizing water is introduced through the inlet hollow 121. The introduced sterilizing water is introduced into the inlet vortex hollow 312 communicating with the inlet hollow 121. Since the lower end of the inlet vortex hollow 312 is closed, the sterilizing water changes its direction in the horizontal direction and enters the outlet housing space 211 through the inlet vortex opening 313.

The sterilizing water flows downward along the flow space FS formed between the inner circumference of the outlet housing body 210 and the outer circumference of the inlet vortex housing body 311 and between the inner circumference of the outlet housing body 210 and the outer circumference of the outlet vortex housing body 321.

The sterilizing water flowing to the lower side of the outlet housing space 211 passes through the vortex base inlet 333 and is formed as a vortex and is introduced into the vortex base hollow 332. The introduced sterilizing water flows along the outlet housing nozzle space 240 in the form of a vortex and is discharged to the outside.

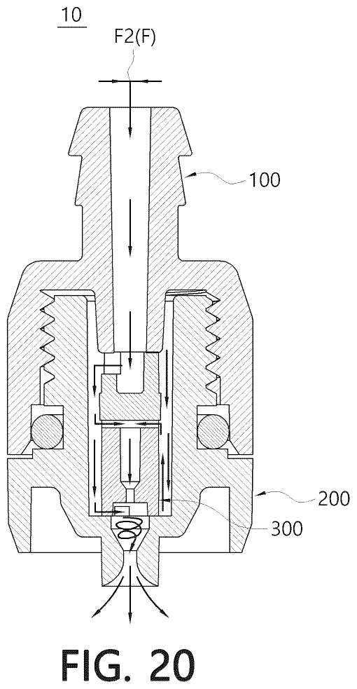

Referring to FIG. 20, a second flow F2 of sterilizing water formed in the discharging nozzle assembly 10 according to an exemplary embodiment of the present invention is illustrated as an example. The second flow F2 may be defined as a flow in which a portion of the introduced sterilizing water pass through the outlet vortex housing 320 and the rest does not pass through the vortex housing 320 to be discharged to the outside.

First, sterilizing water is introduced through the inlet hollow 121. The introduced sterilizing water is introduced into the inlet vortex hollow 312 communicating with the inlet hollow 121. Since the lower end of the inlet vortex hollow 312 is closed, the sterilizing water changes its direction in the horizontal direction and enters the outlet housing space 211 through the inlet vortex opening 313.

In this case, a portion of the sterilizing water enters the outlet vortex hollow 322 through the vortex communication opening 340. The portion of the sterilizing water flows downward along the outlet vortex hollow 322 and enters the vortex base hollow 332.

In addition, the rest of the sterilizing water flows downward along the flow space FS formed between the inner circumference of the outlet housing body 210 and the outer circumference of the inlet vortex housing body 311 and between the inner circumference of the outlet housing body 210 and the outer circumference of the outlet vortex housing body 321. The rest of the sterilizing water flowing to the lower side of the outlet housing space 211 passes through the vortex base inlet 333 and is formed as a vortex and is introduced into the vortex base hollow 332.

Therefore, it will be understood that the portion of the sterilizing water and the rest of the sterilizing water join in the vortex base hollow 332.

In this case, the outlet vortex hollow 322, the vortex base hollow 332, and the outlet housing nozzle space 240 may be arranged to have the same central axis, and to overlap along the up-down direction. Accordingly, the portion of the sterilizing water may continue to flow in the vertical direction and be discharged to the outside.

In addition, the rest of the sterilizing water forms a vortex and is introduced into the vortex base hollow 332, and then flows along the outlet housing nozzle space 240 in the form of a vortex and is discharged to the outside.

The first flow F1 and the second flow F2 described above may be formed simultaneously or at different times. The first flow F1 and the second flow F2 may be collectively referred to as the flow F.

Meanwhile, as described above, the outlet housing nozzle 230 is formed to have different shapes according to the flow of sterilizing water. In particular, since the fourth outlet housing inner circumference 234 has a curved shape rounded to be convex toward the radially inner side, the sterilizing water flowing a predetermined distance may be separated from the fourth outlet housing inner circumference 234 and discharged to the outside.

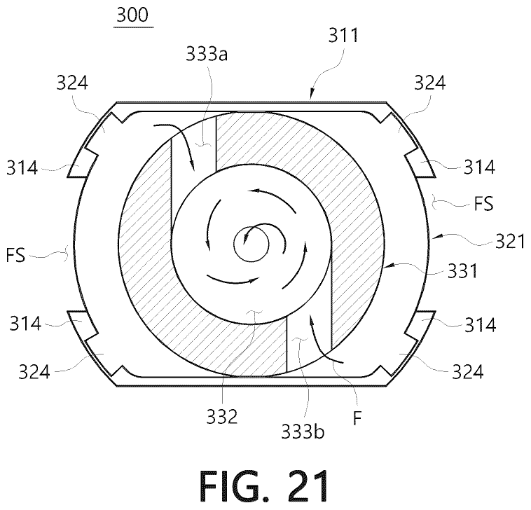

Referring to FIG. 21, a process in which the sterilizing water introduced into the vortex base hollow 332 flows in the form of a vortex is illustrated as an example.

As described above, the vortex base inlet 333 communicating the outlet housing space 211 with the vortex base hollow 332 is disposed eccentrically with respect to the center of the vortex base hollow 332 or the outlet housing nozzle space 240.

Accordingly, the sterilizing water introduced from the outlet housing space 211 through the vortex base inlet 333 flows in the form of a vortex (i.e., the first flow F1). In addition, a portion of the sterilizing water introduced through the vortex communication opening 340 and passing through the outlet vortex hollow 322 may flow in the form of a vortex, and the rest may flow straight and flow out into the outlet housing nozzle space 240 (i.e., the second flow F2).

Therefore, the discharging nozzle assembly 10 and the bidet 1 including the same according to an exemplary embodiment of the present invention described above can discharge sterilizing water in the form of a vortex without a separate power source. Accordingly, cleaning and sterilization efficiency of the bowl (not shown) in which the bidet 1 is installed can be improved.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the scope of the present invention.

<Description of Symbols>

| | |
|---|---|
| 1: bidet | 10: discharging nozzle assembly |
| 20: tank device | 30: water inlet unit |
| 100: inlet housing | 110: inlet housing body |
| 111: inlet housing space | 120: inlet extension |
| 121: inlet hollow | 122: support end |
| 130: coupling member | 140: sealing member |
| 200: outlet housing | 210: outlet housing body |
| 211: outlet housing space | 220: outlet housing base |
| 230: outlet housing nozzle | |
| 231: first outlet housing inner | |
| circumference | |
| 232: second outlet housing inner | |
| circumference | |
| 233: third outlet housing inner | |
| circumference | |
| 234: fourth outlet housing inner | |
| circumference | |
| 240: outlet housing nozzle space | |
| 241: first outlet housing nozzle | |
| space | |
| 242: second outlet housing nozzle | |
| space | |
| 243: third outlet housing nozzle | |
| space | |
| 244: fourth outlet housing nozzle | |
| space | |
| 300: vortex forming member | 310: inlet vortex housing |
| 311: inlet vortex housing body | 312: inlet vortex hollow |
| 313: inlet vortex opening | 314: inlet vortex rib |
| 315: inlet vortex coupling space | 320: outlet vortex housing |
| 321: outlet vortex housing body | 322: outlet vortex hollow |
| 322a: first outlet vortex hollow | 322b: second outlet vortex hollow |
| 322c: third outlet vortex hollow | 323: outlet vortex support |
| | protrusion |
| 324: outlet vortex rib | 325: outlet vortex coupling |
| | extension |
| 330: vortex base | 331: vortex base body |
| 332: vortex base hollow | 333: vortex base inlet |
| 333a: first vortex base inlet | 333b: second vortex base inlet |
| 340: vortex communication opening | C: central axis |
| a: contained angle | a1: first contained angle |
| a2: second contained angle | FS: flow space |
| F1: first flow | F2: second flow |

What is claimed is:

1. A discharging nozzle assembly, comprising:
an inlet housing that communicates the outside and receives fluid;
an outlet housing coupled with the inlet housing, and having an outlet housing space formed therein communicating with the inlet housing and the outside, respectively; and
a vortex forming member supported by the inlet housing and the outlet housing, respectively, and configured to form the flow of the fluid transmitted in communication with the inlet housing and the outlet housing, respectively, into a vortex,
wherein the vortex forming member comprises:
a vortex base communicating with the outlet housing space and the outside,
wherein the vortex base comprises:
a vortex base hollow formed inside and communicating with the outside; and
a vortex base inlet that communicates the vortex base hollow space and the outlet housing space and extends eccentrically with respect to the center of its cross-section to form the flow of the fluid into a vortex.

2. The discharging nozzle assembly of claim 1,
wherein the vortex base comprises:
a vortex base body that is seated on an inner surface of the outlet housing and extends to surround the vortex base hollow in the radial direction, and
wherein the vortex base inlet extends at a predetermined angle with respect to the radial direction of the vortex base body.

3. The discharging nozzle assembly of claim 2, wherein a plurality of vortex base inlets are provided, and the plurality of vortex base inlets are disposed to face each other with the center of the vortex base body therebetween.

4. The discharging nozzle assembly of claim 3,
wherein each of the vortex base body and the vortex base hollow is formed to have a circular cross-section, and
wherein the vortex base inlet comprises:
a first vortex base inlet positioned to be biased to one side with respect to the center of the vortex base body; and
a second vortex base inlet positioned to be biased to the other side with respect to the center of the vortex base body.

5. The discharging nozzle assembly of claim 1,
wherein the vortex forming member comprises:
an inlet vortex housing positioned in the outlet housing space, supported by the inlet housing, communicating with the inlet housing to receive the fluid from the outside, and communicating with the outlet housing space to transmit the fluid.

6. The discharging nozzle assembly of claim 5,
wherein the inlet vortex housing comprises:
an inlet vortex housing body extending in the height direction and supported by the inlet housing;
an inlet vortex hollow formed inside the inlet vortex housing body, with one side thereof facing the inlet housing being open and the other side facing the outlet housing being closed; and
an inlet vortex opening formed recessed into one side of the outer circumference of the inlet vortex housing body and extending in a radial direction to communicate the outlet housing space and the inlet vortex hollow.

7. The discharging nozzle assembly of claim 5,
wherein the inlet vortex housing comprises:
an inlet vortex rib extending in the horizontal direction and supported by an inner surface of the outlet housing so that the center of the cross-section of the vortex forming member and the center of the cross-section of the inlet housing are located on the same axis, and
wherein a flow space in which the fluid flows is formed between an outer surface of the inlet vortex housing and the inner surface of the outlet housing.

8. The discharging nozzle assembly of claim 7, wherein a plurality of inlet vortex ribs are provided, and the plurality of inlet vortex ribs are arranged spaced apart from each other in the length direction and width direction of the inlet vortex housing.

9. The discharging nozzle assembly of claim 1, further comprising an outlet vortex housing accommodated in the outlet housing space, communicating with the outlet housing space and the vortex base hollow space, respectively, and supported by the vortex base.

10. The discharging nozzle assembly of claim 9,
wherein the outlet vortex housing comprises:
an outlet vortex rib formed to protrude outwardly from an outer surface and supported by an inner surface of the outlet housing so that the center of the cross-section of the vortex forming member and the center of the cross-section of the outlet housing are located on the same axis, and
wherein a flow space in which the fluid flows is formed between an outer surface of the outlet vortex housing and the inner surface of the outlet housing.

11. The discharging nozzle assembly of claim 9,
wherein the outlet vortex housing comprises:
an outlet vortex housing body extending in the height direction and coupled to the vortex base; and
an outlet vortex hollow formed inside the outlet vortex housing body, extending in the height direction, and having each end in the extension direction open to communicate with the outlet housing space and the vortex base hollow, respectively.

12. The discharging nozzle assembly of claim 11,
wherein the vortex forming member comprises:
an inlet vortex housing positioned in the outlet housing space, communicating with the inlet housing to receive the fluid from the outside, communicating with the outlet housing space to transmit the fluid, and coupled to the outlet vortex housing; and
a vortex communication opening formed between the inlet vortex housing and the outlet vortex housing and communicating with the outlet housing space and the outlet vortex hollow, respectively.

13. The discharging nozzle assembly of claim 1,
wherein the outlet housing comprises:
an outlet housing nozzle extending in a direction opposite to the inlet housing; and
an outlet housing nozzle space formed through the inside of the outlet housing nozzle and communicating with the vortex base hollow and the outside, respectively.

14. The discharging nozzle assembly of claim 13,
wherein the outlet housing nozzle space is formed to have different cross-sectional areas at least partially along the extension direction of the outlet housing nozzle, and
wherein the outlet housing nozzle comprises:
a plurality of outlet housing inner circumferences surrounding the outlet housing nozzle space in the radial direction along the extension direction thereof.

15. The discharging nozzle assembly of claim 14, wherein among the plurality of outlet housing inner circumferences, any one outlet housing inner circumference located farthest from the vortex forming member is formed rounded to be convex toward the center of the outlet housing nozzle space, while the diameter of its cross-section increases along a direction opposite to the vortex forming member.

16. A bidet, comprising:
a discharging nozzle assembly according to claim 1;
a tank device connected to the discharging nozzle assembly and configured to provide the fluid to the discharging nozzle assembly; and
a water inlet unit that is connected to the tank device and receives the fluid from the outside and provides it to the tank device.
